(19) United States
(12) Patent Application Publication
(10) Pub. No.: US 2026/0049025 A1
(43) Pub. Date: Feb. 19, 2026

(54) ETCHING DEVICE AND METHOD FOR MANUFACTURING WINDOW

(71) Applicant: Samsung Display Co., Ltd., Yongin-si (KR)

(72) Inventors: SUNKYUN PARK, Yongin-si (KR); YONGWOON BYUN, Yongin-si (KR); SEBIN IM, Yongin-si (KR); JINHO CHOI, Yongin-si (KR); LEEGU HAN, Yongin-si (KR)

(21) Appl. No.: 19/225,063

(22) Filed: Jun. 2, 2025

(30) Foreign Application Priority Data
Aug. 14, 2024 (KR) 10-2024-0108983

(51) Int. Cl. C03C 15/00

(52) U.S. Cl. CPC C03C 15/00

(57) ABSTRACT

An etching device includes: a container configured to contain an etching solution and defining at least one opening therein, and a rotating structure disposed within the container and including a rotating blade engageable with the at least one opening, where the rotating blade is provided to be adjustable in length in an extending direction.

This application claims priority to Korean Patent Application No. 10-2024-0108983, filed on Aug. 14, 2024, and all the benefits accruing therefrom under 35 U.S.C. § 119, the content of which in its entirety is herein incorporated by reference.

### BACKGROUND

The present disclosure herein relates to an etching device and a method for manufacturing a window, and more particularly, to an etching device enabling the manufacturing of a foldable window and a method for manufacturing a foldable window.

A display device includes a display region activated in response to electrical signals. The display device senses inputs applied from the outside through the display region and concurrently displays various images, and may thus provide information to users. The recent development of display devices configured in various shapes has driven extensive research on foldable display devices, in particular, resulting in a growing demand for efficient etching methods for ultra-thin glass (UTG) to enable foldable features.

### SUMMARY

The present disclosure provides an etching device capable of easily etching a window.

The present disclosure also provides a method for manufacturing a window, capable of manufacturing a window through a simple process.

An embodiment of the invention provides an etching device including a container for containing an etching solution and defining at least one opening therein, and a rotating structure disposed within the container and including a rotating blade engageable with the at least one opening, where the rotating blade is provided to be adjustable in length in an extending direction.

In an embodiment, the rotating structure may include a rotating shaft extending in one direction, and the rotating blade may extend toward an inner surface of the container from the rotating shaft.

In an embodiment, the rotating structure may open and close the at least one opening by adjusting the length of the rotating blade in the extending direction.

In an embodiment, the at least one opening may extend in the one direction.

In an embodiment, the rotating structure may include a first state in which one end of the rotating blade is engaged with the at least one opening, a second state in which the one end of the rotating blade is separated from the at least one opening, and a third state in which the rotating blade rotates around the rotating shaft.

In an embodiment, in the first state, the rotating blade may have a first length in the extending direction, in the second state, the rotating blade may have a second length in the extending direction less than the first length, and in the third state, the rotating blade may have the second length.

In an embodiment, the container may include an outer surface on which a target substrate is mounted, and an inner surface in contact with the etching solution, and the at least one opening may be defined as passing through the outer surface and the inner surface.

In an embodiment, the outer surface may include a plane parallel to the target substrate.

In an embodiment, the inner surface of the container may define a receiving space for containing the etching solution, and in a plan view, the receiving space may have a circular shape.

In an embodiment, the at least one opening of the container may include n openings, the rotating blade of the rotating structure may include n rotating blades corresponding to the n openings, and n may be an integer of 2 or greater.

In an embodiment, the at least one opening may include first to fourth openings, the rotating blades may include a first sub-rotating blade corresponding to the first opening, a second sub-rotating blade corresponding to the second opening, a third sub-rotating blade corresponding to the third opening, and a fourth sub-rotating blade corresponding to the fourth opening, and the first to fourth sub-rotating blades may be provided to be adjustable in the length to open and close the first to fourth openings, respectively.

In an embodiment, the at least one opening of the container may include m openings, the rotating structure may include m+a rotating blades, m rotating blades of the m+a rotating blades may correspond to the m openings, the m rotating blades may be provided to be adjustable in the length to open and close the m openings, respectively, the m may be an integer of 1 or greater, and the a may be an integer of 0 or greater.

In an embodiment, the m may be 1 and the a may be 3, the rotating structure may include a first rotating blade corresponding to the one opening, and second rotating blades including three other rotating blades excluding the first rotating blade among the m+a rotating blades, and the first rotating blade may be provided to be adjustable in the length to open and close the one opening.

In an embodiment of the invention, a method for manufacturing a window includes preparing an etching unit including a container containing an etching solution and defining at least one opening therein, and a rotating structure disposed within the container and including a rotating blade engageable with the at least one opening, disposing a target substrate to overlap the at least one opening on an outer surface of the container, adjusting a length of the rotating blade to separate the rotating blade from the at least one opening, and etching a portion of the target substrate by rotating the rotating blade to form a pattern on the target substrate.

In an embodiment, a state in which one end of the rotating blade is engaged with the at least one opening may be defined as a first state, and a state in which the one end of the rotating blade is separated from the at least one opening may be defined as a second state, before the disposing of the target substrate, the rotating structure may be in the first state, and after the disposing of the target substrate, the rotating structure may turn from the first state to the second state.

In an embodiment, in the second state, a portion of the target substrate may be exposed through the at least one opening and may come into contact with the etching solution.

In an embodiment, in the forming of the pattern on the target substrate, the rotating structure may turn from the second state to a third state in which the rotating blade rotates around a rotating shaft.

In an embodiment, the target substrate may be a glass substrate.

In an embodiment, the target substrate may include a first non-folding region, a second non-folding region spaced apart from the first non-folding region, and a folding region disposed between the first non-folding region and the second non-folding region, and in the disposing of the target substrate, the at least one opening may overlap the folding region of the target substrate.

In an embodiment, the pattern may be formed in the folding region and may include a groove extending in the one direction, and a depth of the groove may be less than a thickness of the target substrate.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1A is a perspective view showing a state in which a display device according to an embodiment of the invention is unfolded;

FIG. 1B is a perspective view showing an inner-folding process of the display device shown in FIG. 1A;

FIG. 1C is a perspective view showing an outer-folding process of the display device shown in FIG. 1A;

FIG. 2A is a perspective view showing a state in which a display device according to an embodiment of the invention is unfolded;

FIG. 2B is a perspective view showing an inner-folding process of the display device shown in FIG. 2A;

FIG. 2C is a perspective view showing an outer-folding process of the display device shown in FIG. 2A;

FIG. 3 is an exploded perspective view of a display device according to an embodiment of the invention;

FIG. 4 is a cross-sectional view of a display device according to an embodiment of the invention;

FIGS. 5A and 5B are each views schematically showing a cross-section of a display device of an embodiment in a folded state;

FIG. 6A is a cross-sectional view showing a window according to an embodiment of the invention;

FIG. 6B is a cross-sectional view showing a portion of a window according to an embodiment of the invention;

FIGS. 7A and 7B are each views schematically showing a cross-section of one component included in a display device according to an embodiment;

FIG. 8A is a perspective view of an etching device according to an embodiment of the invention;

FIG. 8B is an exploded perspective view of an etching device according to an embodiment of the invention;

FIGS. 8C, 8E, and 8G are each cross-sectional views taken along line II-II′ of FIG. 8A;

FIG. 8D is a cross-sectional view showing a portion corresponding to region AA of FIG. 8C;

FIG. 8F is a cross-sectional view showing a portion corresponding to region BB of FIG. 8E;

FIG. 9 is a flowchart showing a method for manufacturing a window according to an embodiment of the invention;

FIGS. 10A to 10N are views showing some processes in a method for manufacturing a window according to an embodiment of the invention; and

FIGS. 11A to 11L are views showing some processes in a method for manufacturing a window according to an embodiment of the invention.

### DETAILED DESCRIPTION

Hereinafter, embodiments of the invention will be described with reference to the drawings.

As used herein, when an element (or a region, a layer, a portion, etc.) is referred to as being “on,” “connected to,” or “coupled to” another element, it means that the element may be directly connected to/coupled to the other element, or that a third element may be disposed therebetween.

Like numbers refer to like elements throughout. In addition, in the drawings, the thickness, the ratio, and the dimensions of elements are exaggerated for an effective description of technical contents. “At least one” is not to be construed as limiting “a” or “an.” “Or” means “and/or.” The term “and/or” includes all combinations of one or more of which associated configurations may define.

Although the terms “first”, “second”, etc. may be used herein to describe various elements, these elements should not be limited by these terms. These terms are only used to distinguish one element from another element. For example, a first element may be referred to as a second element, and similarly, a second element may be referred to as a first element without departing from the teachings of the present disclosure. The singular forms are intended to include the plural forms as well, unless the context clearly indicates otherwise.

In addition, terms such as “below,” “lower,” “above,” “upper,” and the like are used to describe the relationship of the configurations shown in the drawings. The terms are used as a relative concept and are described with reference to the direction indicated in the drawings.

It should be understood that the term “comprise” or “have” is intended to specify the presence of stated features, integers, steps, operations, elements, components, or combinations thereof in the disclosure, but do not preclude the presence or addition of one or more other features, integers, steps, operations, elements, components, or combinations thereof.

As used herein, being “disposed directly on” may indicate that there is no additional layer, film, region, plate, or the like between a part and another part such as a layer, a film, a region, a plate, or the like. For example, being “disposed directly on” may indicate that two layers or two members are disposed without using an additional member such as an adhesive member, therebetween.

Unless otherwise defined, all terms (including technical and scientific terms) used herein have the same meaning as commonly understood by one of ordinary skill in the art to which the present disclosure belongs. In addition, terms, such as those defined in commonly used dictionaries, should be interpreted as having a meaning that is consistent with their meaning in the context of the relevant art and should not be interpreted in an idealized or overly formal sense unless expressly so defined herein.

Hereinafter, a window according to an embodiment of the invention and a display device according to an embodiment of the invention will be described with reference to the accompanying drawings.

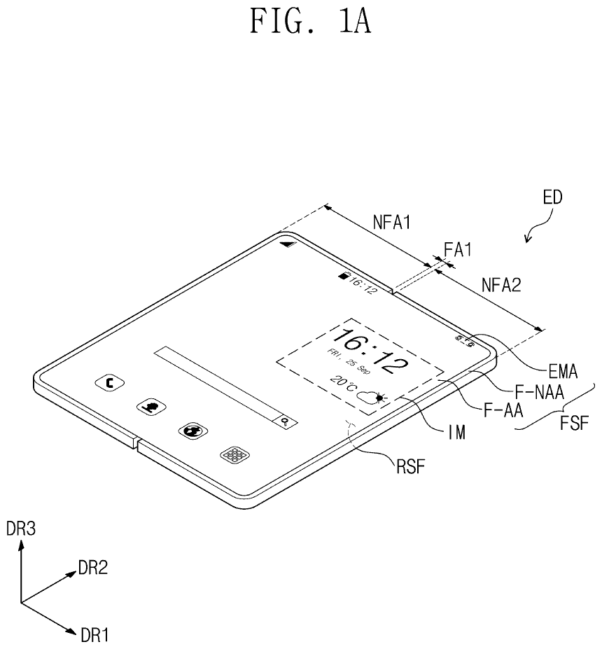

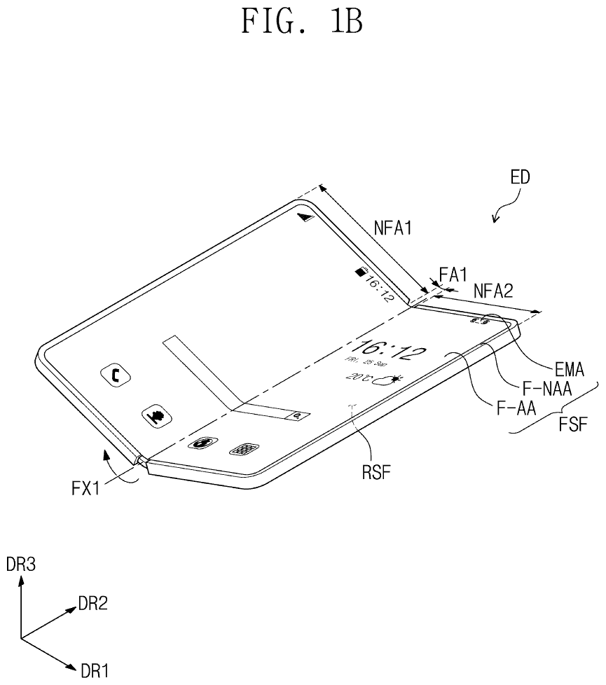

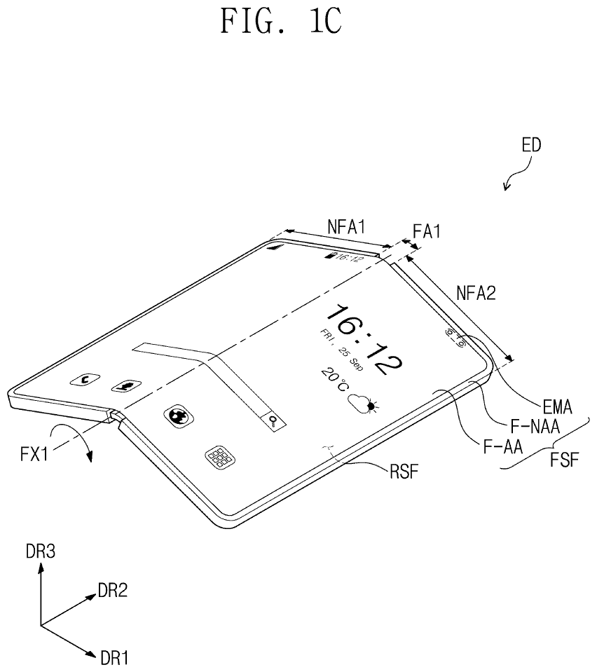

FIG. 1A is a perspective view showing a state in which a display device according to an embodiment is unfolded. FIG. 1B is a perspective view showing an inner-folding process of the display device shown in FIG. 1A. FIG. 1C is a perspective view showing an outer-folding process of the display device shown in FIG. 1A.

A display device ED may be a device activated according to electrical signals. For example, the display device ED may be a mobile phone, a tablet, a car navigation system, a game console, or a wearable device, but the embodiment of the invention is not limited thereto. In FIG. 1A and the like, herein, as an example, the display device ED is shown as a mobile phone.

Referring to FIGS. 1A to 1C, the display device ED according to an embodiment may include a first display surface FSF defined by a first direction DR1 and a second direction DR2 crossing the first direction DR1. The display device ED may provide an image IM to users through the first display surface FSF. The display device ED according to an embodiment may display the image IM towards a third direction DR3 through the first display surface FSF parallel to each of the first direction DR1 and the second direction DR2. Herein, a front surface (or an upper surface) and a rear surface (or a lower surface) of respective members are defined with respect to a direction in which the image IM is displayed. The front and rear surfaces may oppose each other in the third direction DR3 and a normal direction of each of the front and rear surfaces may be parallel to the third direction DR3.

The display device ED according to an embodiment may include the first display surface FSF and a second display surface RSF. The first display surface FSF may include an active region F-AA and a peripheral region F-NAA. The active region F-AA may include an electronic module region EMA. The second display surface RSF may be defined as a surface opposing at least a portion of the first display surface FSF. That is, the second display surface RSF may be defined as a portion of the rear surface of the display device ED.

The display device ED according to an embodiment may detect external inputs applied from the outside. The external inputs may include various forms of inputs provided from outside the display device ED. For example, the external inputs may include external inputs applied when approaching the display device ED or being adjacent by a predetermined distance (e.g., hovering), as well as contact by body parts such as a user's hand. In addition, the external inputs may have various forms such as force, pressure, temperature, and light.

While FIG. 1A and the following drawings show the first to third directions DR1 to DR3, directions indicated by the first to third directions DR1, DR2, and DR3 described herein are relative concepts, and may thus be changed to other directions.

The active region F-AA of the display device ED may be a region activated according to electrical signals. The display device ED according to an embodiment may display the image IM through the active region F-AA. In addition, the active region F-AA may detect various forms of external inputs. The peripheral region F-NAA is adjacent to the active region F-AA. The peripheral region F-NAA may have a predetermined color. The peripheral region F-NAA may cover the active region F-AA. Accordingly, the shape of the active region F-AA may be substantially defined by the peripheral region F-NAA. However, this is shown as an example, and the peripheral region F-NAA may be disposed adjacent to only one side of the active region F-AA, or may not be provided. The display device ED according to an embodiment of the invention may include various forms of active regions and is not limited to any one embodiment.

The display device ED may include a folding region FA1 and non-folding regions NFA1 and NFA2. In an embodiment, the non-folding regions NFA1 and NFA2 may be disposed adjacent to the folding region FA1 with the folding region FA1 therebetween. The display device ED of an embodiment may include a first non-folding region NFA1 and a second non-folding region NFA2, which are spaced apart with the folding region FA1 therebetween in the first direction DR1. For example, the first non-folding region NFA1 may be disposed at one side of the folding region FA1 in the first direction DR1, and the second non-folding region NFA2 may be disposed at the other side of the folding region FA1 in the first direction DR1.

FIGS. 1A to 1C show an embodiment of the display device ED including one folding region FA1, but the embodiment of the invention is not limited thereto, and in the display device ED, a plurality of folding regions may be defined. For example, the display device according to an embodiment may include two or more folding regions and three or more non-folding regions disposed with each of the folding regions therebetween.

Referring to FIG. 1B, the display device ED according to an embodiment may be folded with respect to a first folding axis FX1. The first folding axis FX1 is a virtual axis extending in a direction of the second direction DR2, and the first folding axis FX1 may be parallel to a long side direction of the display device ED. The first folding axis FX1 may extend along the second direction DR2 on the first display surface FSF.

The display device ED may be folded with respect to the first folding axis FX1 to become in-folded such that one region overlapping the first non-folding region NFA1 and the other region overlapping the second non-folding region NFA2 on the first display surface FSF face each other.

In the display device ED according to an embodiment, the second display surface RSF may be viewed in an in-folded state by users. The second display surface RSF may further include an electronic module region in which an electronic module including various components is disposed, and is not limited to any one embodiment.

Referring to FIG. 1C, the display device ED may be folded with respect to the first folding axis FX1 to become out-folded such that one region overlapping the first non-folding region NFA1 and the other region overlapping the second non-folding region NFA2 on the second display surface RSF face each other.

However, the embodiment of the invention is not limited thereto, and the display device ED may be folded with respect to a plurality of folding axes such that portions of each of the first display surface FSF and the second display surface RSF may face each other, and the number of folding axes and the number of the corresponding non-folding regions are not particularly limited.

The electronic module region EMA may have various electronic modules disposed therein. For example, the electronic module may include at least any one of a camera, a speaker, a light detection sensor, or a heat detection sensor. The electronic module region EMA may detect an external subject received through the first display surface FSF or the second display surface RSF, or provide sound signals such as voice to the outside through the first display surface FSF or the second display surface RSF. The electronic modules may include a plurality of components, and are not limited to any one embodiment.

The electronic module region EMA may be surrounded by the active region F-AA and the peripheral region F-NAA. However, the embodiment of the invention is not limited thereto, and the electronic module region EMA may be disposed in the active region F-AA, but is not limited to any one embodiment.

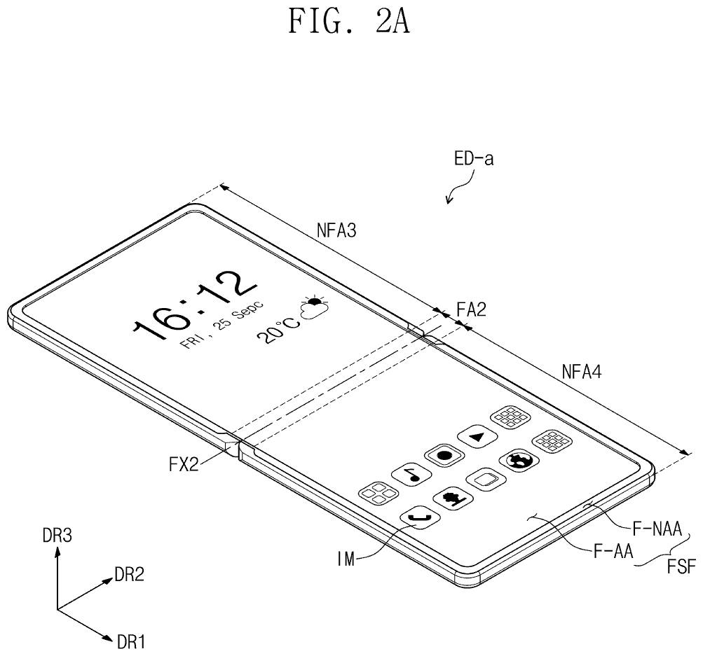

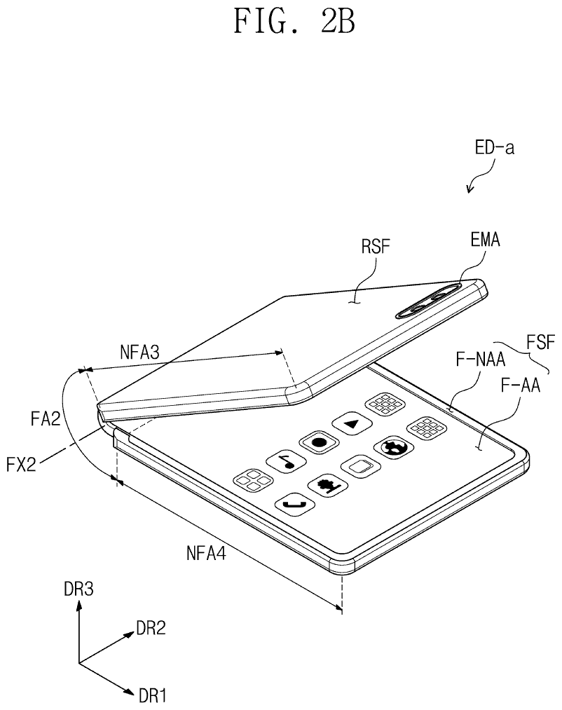

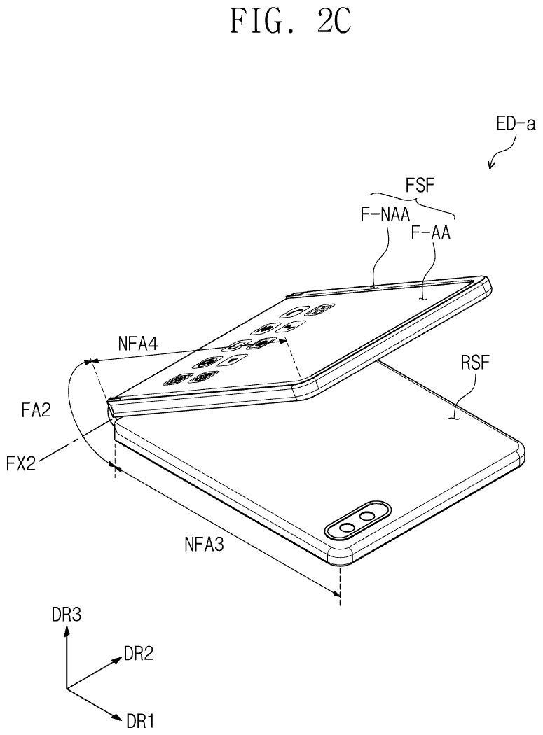

FIG. 2A is a perspective view showing a state in which a display device according to an embodiment is unfolded. FIG. 2B is a perspective view showing an inner-folding process of the display device shown in FIG. 2A. FIG. 2C is a perspective view showing an outer-folding process of the display device shown in FIG. 2A.

A display device ED-a according to an embodiment may be folded with respect to a second folding axis FX2 extending in one direction parallel to the second direction DR2. FIG. 2B shows a case in which a direction that the second folding axis FX2 extends is parallel to a direction that a short side of the display device ED-a extends. However, the embodiment of the invention is not limited thereto.

The display device ED-a according to an embodiment may include at least one folding region FA2 and non-folding regions NFA3 and NFA4 adjacent to the folding region FA2. The non-folding regions NFA3 and NFA4 may be spaced apart with the folding region FA2 therebetween.

The folding region FA2 has a predetermined curvature and a predetermined radius of curvature. In an embodiment, the first non-folding region NFA3 and the second non-folding region NFA4 may face each other, and the display device ED-a may be inner-folded such that the display surface FSF is not exposed to the outside. In addition, referring to FIG. 2, in an embodiment, the display device ED-a may be outer-folded such that the first display surface FSF is exposed to the outside.

The display device ED-a according to an embodiment may include a second display surface RSF, and the second display surface RSF may be defined as a surface opposing at least a portion of the first display surface FSF. The second display surface RSF may include an electronic module region EMA in which electronic modules including various components are disposed. In addition, images or videos may be displayed on at least a portion of the second display surface RSF.

In an embodiment, when the display device ED-a is in the unfolded state, the first display surface FSF may be viewed by users and when being in the inner-folded state, the second display surface RSF may be viewed by users.

In an embodiment, the display devices ED and ED-a may be configured such that an inner-folding operation or an outer-folding operation is mutually repeated from an unfolding operation, but the embodiment of the invention is not limited thereto. In an embodiment, the display devices ED and ED-a may be configured to select any one among an unfolding operation, an inner-folding operation, and an outer-folding operation. In addition, when a plurality of folding regions are included, a folding direction of at least one of the plurality of folding regions may be different from a folding direction of the other folding regions. For example, when two folding regions are included, two non-folding regions with one folding region therebetween are folded by an inner-folding operation, and the two non-folding regions with the other folding region therebetween may be folded by an outer-folding operation.

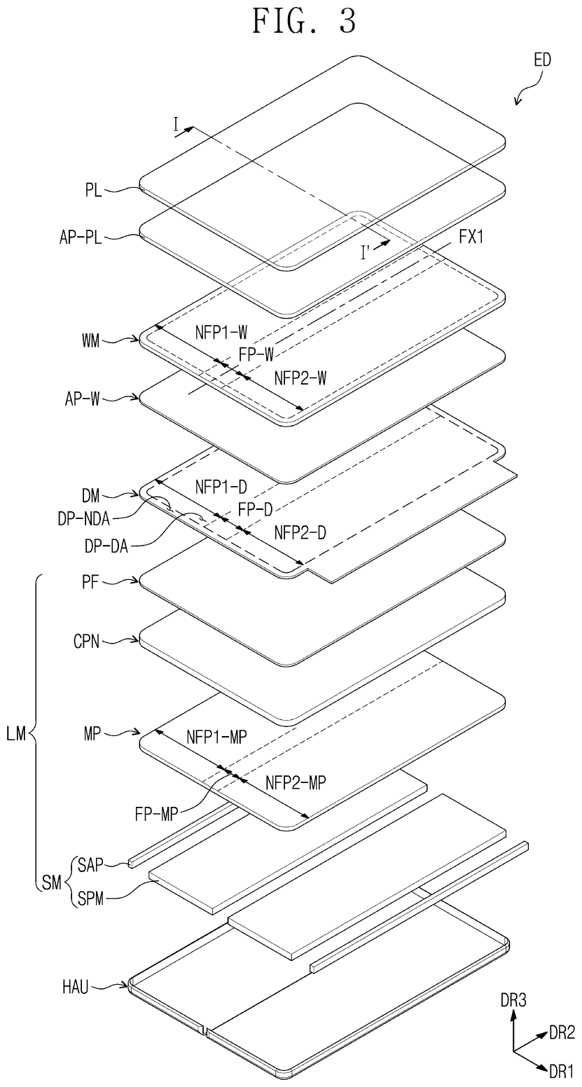

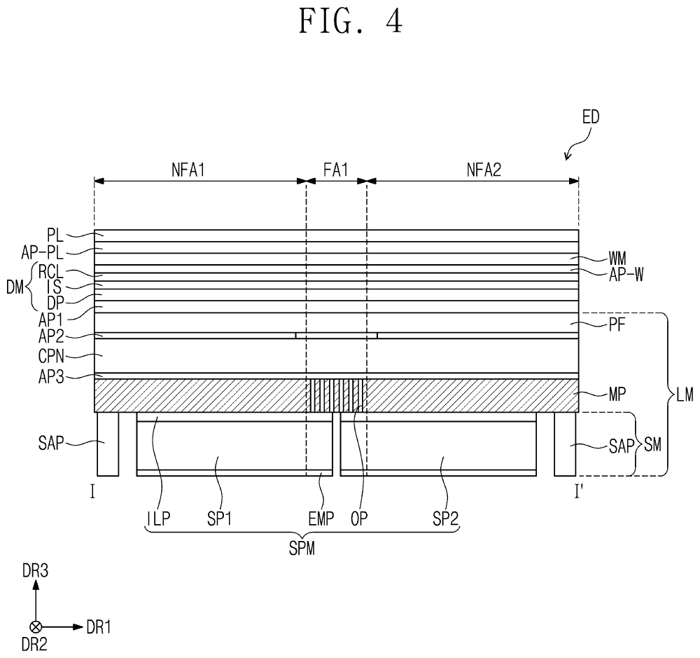

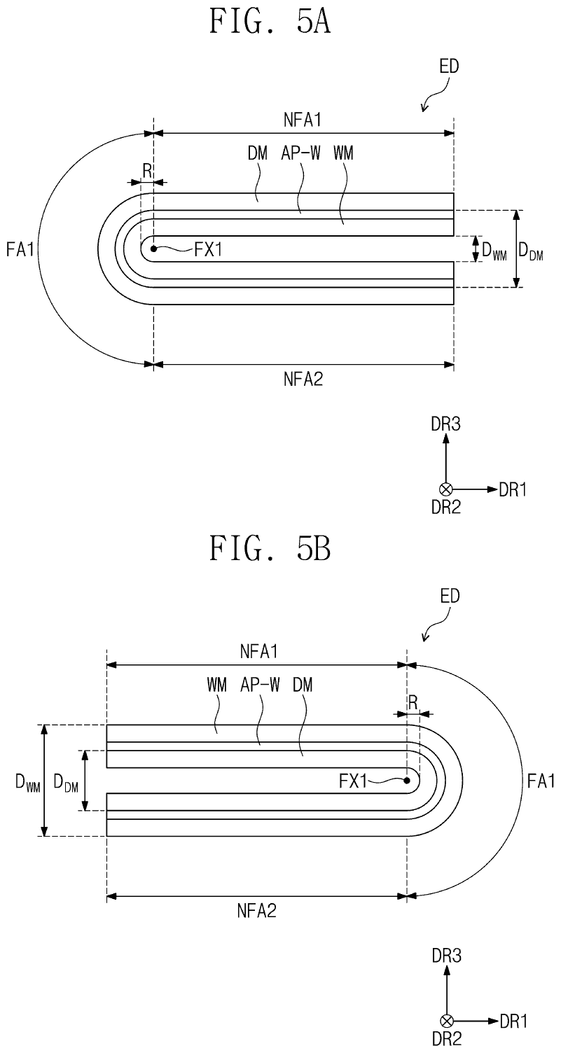

FIG. 3 is an exploded perspective view of a display device according to an embodiment, and FIG. 4 is a cross-sectional view of a display device according to an embodiment. FIG. 3 shows an exploded perspective view of a display device according to an embodiment shown in FIG. 1A as an example. FIG. 4 is a cross-sectional view taken along line I-I′ of FIG. 3.

FIGS. 3 and 4, and the like show a case in which a folding axis FX1 of the display device ED shown in FIG. 1A and the like is parallel to a long side of the display device ED, but the embodiment of the invention is not limited thereto, and descriptions with reference to the drawings below may also apply to a case in which a folding axis FX2 is parallel to a short side of the display device as shown in FIG. 2A and the like.

Referring to FIGS. 3 and 4, the display device ED of an embodiment may include a display module DM and a window WM disposed above the display module DM. In addition, the display device ED of an embodiment may further include a lower module LM disposed below the display module DM.

The display device ED of an embodiment may further include a window adhesive layer AP-W disposed between the display module DM and the window WM, and may also further include a protection film PL and an adhesive protection layer AP-PL disposed above the window WM. In another embodiment, in the display device ED of an embodiment, the protection film PL and the adhesive protection layer AP-PL may not be provided. When the protection film PL and the adhesive protection layer AP-PL are not provided, the window WM may be an uppermost surface of the display device ED.

The lower module LM may include a support plate MP disposed below the display module DM. The lower module LM may also be referred to as a support member.

The display device ED may include a housing HAU accommodating the display module DM, the lower module LM, and the like. The housing HAU may be bonded to the window WM. Although not shown, the housing HAU may further include a hinge structure to make folding or bending easy. The window WM may be a cover window disposed on the display module DM.

The display device ED of an embodiment may include a window adhesive layer AP-W disposed between display module DM and the window WM. The window adhesive layer AP-W may be an optically clear adhesive film (OCA) or an optically clear adhesive resin layer (OCR). In another embodiment, in an embodiment, the window adhesive layer AP-W may not be provided.

The window WM may cover the entire upper surface of the display module DM. The window WM may have a shape corresponding to the shape of the display module DM. The window WM includes glass and may be used as a cover window of the display device ED.

The window WM may include a folding portion FP-W and non-folding portions NFP1-W and NFP2-W. The first non-folding portion NFP1-W and the second non-folding portion NFP2-W of the window WM may be spaced apart in the first direction DR1 with the folding portion FP-W therebetween. The folding portion FP-W may be a portion corresponding to the folding region FA1 (see FIG. 1A), and the non-folding portions NFP1-W and NFP2-W may be portions corresponding to the non-folding regions NFA1 and NFA2 (see FIG. 1A).

In an embodiment, the window WM may have a structure of bonding glass in which a plurality of glass substrates are bonded together. The bonded glass substrates may each be a tempered glass substrate. In addition, the bonded glass substrates may each be an ultra thin glass substrate. The window WM according to an embodiment will be described in more detail later.

The display module DM may display images according to electrical signals and transmit/receive information on external inputs. The display module DM may include a display region DP-DA and a non-display region DP-NDA. The display region DP-DA may be defined as a region outputting images provided from the display module DM.

The non-display region DP-NDA is adjacent to the display region DP-DA. For example, the non-display region DP-NDA may surround the display region DP-DA. However, this is shown as an example, and the non-display region DP-NDA may be defined in various shapes, and is not limited to any one embodiment. According to an embodiment, the display region DP-DA of the display module DM may correspond to at least a portion of the active region F-AA (see FIG. 1A).

In an embodiment, the display module DM may include a display panel DP. The display panel DP may be a light emitting-type display panel, but is not particularly limited thereto. For example, the display panel DP may be an organic light emitting display panel or an inorganic light emitting display panel. An emission layer of the organic light emitting display panel may include an organic light emitting material. An emission layer of the inorganic light emitting display panel may include quantum dots, quantum rods, and the like.

The display module DM may further include an input sensor IS. The input sensor IS may be directly disposed on the display panel DP. The input sensor IS may include a plurality of sensing electrodes. The input sensor IS may detect external inputs using a self-cap method or a mutual-cap method. The input sensor IS may also detect inputs by an active-type input device.

The input sensor IS may be directly formed on the display panel DP through a continuous process when the display panel DP is manufactured. However, the embodiment of the invention is not limited thereto, and the input sensor IS may be manufactured as a separate panel from the display panel DP, and be attached to the display panel DP through an adhesive layer (not shown).

In addition, the display module DM may further include an optical layer RCL. The optical layer RCL may serve to reduce reflection by external light. For example, the optical layer RCL may include a polarizing layer or a color filter layer. However, the embodiment of the invention is not limited thereto, and the optical layer RCL may include optical members for improving display quality of the display device ED.

In an embodiment, the optical layer RCL may be directly disposed on the input sensor IS. In addition, when the input sensor IS is not provide in the display module DM, the optical layer RCL may be directly disposed on the display panel DP. However, the embodiment of the invention is not limited thereto, and the optical layer RCL may be disposed on the display panel DP or the input sensor IS, using a separate adhesive member.

The display module DM may include a folding display portion FP-D and non-folding display portions NFP1-D and NFP2-D. The folding display portion FP-D may be a portion corresponding to the folding region FA1 (see FIG. 1A), and the non-folding display portions NFP1-D and NFP2-D may be portions corresponding to the non-folding regions NFA1 and NFA2 (see FIG. 1A).

The folding display portion FP-D may correspond to a portion that is folded or bent with respect to the first folding axis FX1 (see FIGS. 1B and 1C). The display module DM may include a first non-folding display portion NFP1-D and a second non-folding display portion NFP2-D, and the first non-folding display portion NFP1-D and the second non-folding display portion NFP2-D may be spaced apart with the folding display portion FP-D therebetween.

In the display device ED according to an embodiment, the lower module LM may include a support plate MP. In addition, in an embodiment, the lower module LM may further include at least one of a support module SM, a protection layer PF, or a buffer layer CPN. For example, the display device ED according to an embodiment may include a support plate MP disposed below a display module DM, a protection layer PF and a buffer layer CPN disposed between the support plate MP and the display module DM, and a support module SM disposed below a support plate MP.

In an embodiment, the support plate MP may be disposed below the display module DM. The support plate MP may include a folding support portion FP-MP and non-folding support portions NFP1-MP and NFP2-MP. The first non-folding support portion NFP1-MP and the second non-folding support portion NFP2-MP of the support plate MP may be spaced apart with the folding support portion FP-MP therebetween. The folding support portion FP-MP may be a portion corresponding to the folding region FA1 (see FIG. 1A), and the non-folding support portions NFP1-MP and NFP2-MP may be portions corresponding to the non-folding regions NFA1 and NFA2 (see FIG. 1A).

Referring to FIGS. 3 and 4, a protection layer PF may be disposed between the display module DM and the support plate MP. The protection layer PF may be a layer disposed below the display module DM to protect a rear surface of the display module DM. The protection layer PF may overlap the entire display module DM. The protection layer PF may include a plastic material. For example, the protection layer PF may be a polyimide film or a polyethylene terephthalate film. However, this is presented as an example, and the material of the protection layer PF is not limited thereto.

The display device ED according to an embodiment may include the support module SM. The support module SM may include a support portion SPM and a filling portion SAP. The support portion SPM may be a portion overlapping most regions of the display module DM. The filling portion SAP may be a portion disposed outside the support portion SPM and overlapping an outer portion of the display module DM.

The support module SM may include support layers SP1 and SP2. The support layers SP1 and SP2 may include a first sub support layer SP1 and a second sub support layer SP2 spaced apart in the first direction DR1. The first sub support layer SP1 and the second sub support layer SP2 may be spaced apart at a portion corresponding to the first folding axis FX1 (see FIGS. 1B and 1C). The support layers SP1 and SP2 are spaced apart from each other in the folding region FA1 to serve as the first sub support layer SP1 and the second sub support layer SP2, thereby improving folding or bending characteristics of the display device ED. Although not shown, the support layers SP1 and SP2 may include a cushion layer (not shown) and a lower support plate (not shown) which are stacked in a thickness direction.

The support plate (not shown) may include a metal material or a polymer material. For example, the lower support plate may be formed including stainless steel, aluminum, copper, or an alloy thereof.

The cushion layer (not shown) may prevent the support plate MP from being pressed and deformed due to external impact and force. The cushion layer (not shown) may include sponge, foam, or elastomer such as a urethane resin. In addition, the cushion layer (not shown) may be formed including at least one of an acryl-based polymer, a urethane-based polymer, a silicone-based polymer, or an imide-based polymer. However, the embodiment of the invention is not limited thereto. The cushion layer (not shown) may be disposed below the support plate MP or below the lower support plate (not shown).

In addition, the support module SM may further include at least one of a shielding layer EMP or an interlayer adhesive layer ILP. The shielding layer EMP may be an electromagnetic wave shielding layer or a heat dissipation layer. In addition, the shielding layer EMP may serve as a bonding layer. The support module SM and the housing HAU may be bonded using the shielding layer EMP. The shielding layer EMP may be disposed below the support layers SP1 and SP2.

The support module SM may further include an interlayer adhesive layer ILP disposed above the support layers SP1 and SP2. The interlayer adhesive layer ILP may bond the support plate MP and the support module SM. The interlayer adhesive layer ILP may be provided in the form of a bonding resin layer or an adhesive tape. For example, the interlayer adhesive layer ILP may have a portion overlapping the folding display portion FP-D removed therefrom. However, the embodiment of the invention is not limited thereto, and the interlayer adhesive layer ILP may overlap the entire folding display portion FP-D.

The filling portion SAP may be disposed outside the support layers SP1 and SP2. The filling portion SAP may be disposed between the support plate MP and the housing HAU. The filling portion SAP may fill a space between the support plate MP and the housing HAU, and fix the support plate MP.

Referring to FIGS. 3 and 4, the display device ED of an embodiment may include the buffer layer CPN in the lower module LM. The buffer layer CPN may serve as a thickness compensation layer compensating for the thickness below the display module DM or serve as a support layer supporting the display module DM. The buffer layer CPN may not be provided in another embodiment.

Combinations of components included in the lower module LM in the display device ED of an embodiment may vary depending on the size and shape of the display device ED or operation characteristics of the display device ED.

In addition, the display device ED of an embodiment may further include at least one adhesive layer AP1, AP2, or AP3. For example, the first adhesive layer AP1 may be disposed between the display module DM and the protection layer PF, the second adhesive layer AP2 may be disposed between the protection layer PF and the buffer layer CPN, and the third adhesive layer AP3 may be disposed between the support plate MP and the buffer layer CPN. The at least one adhesive layer AP1, AP2, or AP3 may be an optically clear adhesive film (OCA) or an optically clear adhesive resin layer (OCR). However, the embodiment of the invention is not limited thereto, and the at least one adhesive layer AP1, AP2, or AP3 may be an adhesive layer having a transmittance of about 80% or less.

The display device ED of an embodiment may further include a protection film PL disposed above the window WM. The protection film PL may be disposed above the window WM to protect the window WM from external environments. However, in the display device ED of an embodiment, the protection film PL may not be provided, and the window WM may be an uppermost surface of the display device ED.

The adhesive protection layer AP-PL may be further disposed between the window WM and the protection film PL. The adhesive protection layer AP-PL may be an optically clear adhesive layer. When the display device ED of an embodiment includes the protection film PL, the protection film PL may be a layer exposed to the outside in the display device ED.

The protection film PL may have optical properties such as a transmittance of about 90% or greater in a visible light region and a haze value of less than about 1%. The protection film PL may include a polymer film. In addition, the protection film PL may have the polymer film as a base layer and further include functional layers such as a hard coating layer, an anti-fingerprint coating layer, and an antistatic coating layer on the base layer. The protection film PL used in the display device ED according to an embodiment may have flexibility.

FIGS. 5A and 5B are each views schematically showing a cross-section of a display device ED of an embodiment in a folded state. FIGS. 5A and 5B schematically show only the components of the display module DM, the window adhesive layer AP-W, and the window WM of the display device ED.

The drawing shown in FIG. 5A is a cross-section showing an in-folded state, and in the folded state of the display device ED according to an embodiment, a distance D_{WM} between upper surfaces, which face each other, of the window WM may be less than a distance D_{DM} between upper surfaces, which face each other, of the display module DM. In the display device ED of an embodiment, a radius of curvature R of the folding region FA1, which is in-folded with respect to the first folding axis FX1, may be about 1 mm or less. That is, since the window WM of an embodiment, which will be described below, includes a glass substrate in which a concave portion is defined corresponding to the folding region, the bending radius limit may be reduced such that the radius of curvature R of the folding region FA1 is about 1 mm or less. However, the embodiment of the invention is not limited thereto, and the radius of curvature R of the folding region FA1 may be greater than about 1 mm.

The drawing shown in FIG. 5B is a cross-section showing an out-folded state, and in the folded state of the display device ED according to an embodiment, a distance D_{DM} between upper surfaces, which face each other, of the display module DM may be less than a distance D_{WM} between upper surfaces, which face each other, of the window WM. In the display device ED of an embodiment, a radius of curvature R of the folding region FA1, which is out-folded with respect to the first folding axis FX1, may be about 1 mm or less. That is, since the window WM of an embodiment, which will be described below, includes a glass substrate in which a concave portion is defined corresponding to the folding region, the bending radius limit may be reduced such that the radius of curvature R of the folding region FA1 is about 1 mm or less. However, the embodiment of the invention is not limited thereto, and the radius of curvature R of the folding region FA1 may be greater than about 1 mm.

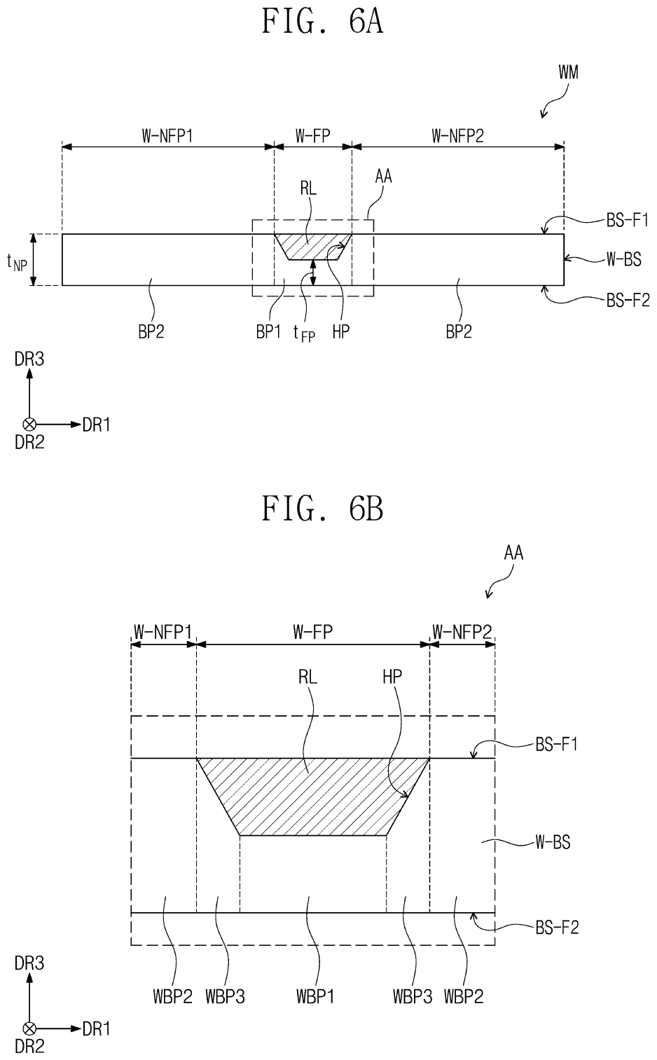

FIG. 6A is a cross-sectional view showing a window according to an embodiment. FIG. 6B is a cross-sectional view showing a portion of a window according to an embodiment. FIG. 6B is a cross-section of a window WM according to an embodiment, corresponding to region AA of FIG. 6A.

Referring to FIGS. 6A and 6B, the window WM of an embodiment may include a base substrate W-BS having a concave portion HP defined on at least one surface and a resin layer RL disposed within the concave portion HP. Herein, the concave portion HP may be referred to as a pattern.

The base substrate W-BS of an embodiment may include a first non-folding portion W-NFP1, a second non-folding portion W-NFP2, and a folding portion W-FP disposed between the first non-folding portion W-NFP1 and the second non-folding portion W-NFP2. The first non-folding portion W-NFP1 and the second non-folding portion W-NFP2 of the base substrate W-BS may be spaced apart in the first direction DR1 with the folding portion W-FP therebetween. The folding portion W-FP may be a portion corresponding to the folding region FA1 (see FIG. 1A), and the non-folding portions W-NFP1 and W-NFP2 may be portions corresponding to the non-folding regions NFA1 and NFA2 (see FIG. 1A). The phrase “a region/portion corresponds to a region/portion” indicates that the regions/portions overlap each other, but they are not limited to having the same size of area.

In the window WM of an embodiment, the base substrate W-BS may be a glass substrate. The base substrate W-BS may be a tempered glass substrate. The base substrate W-BS may be a chemically strengthened or thermally strengthened glass substrate.

In the window WM of an embodiment, the base substrate W-BS may include a first base surface BS-F1 and a second base surface BS-F2 that oppose each other with respect to the third direction DR3. In the window WM of an embodiment, the concave portion HP may be defined in at least one of the first base surface BS-F1 or the second base surface BS-F2. For example, the concave portion HP may be defined in the first base surface BS-F1 of the base substrate W-BS. However, the embodiment of the invention is not limited thereto, and unlike what is shown in FIG. 6A, the concave portion HP may be defined in each of the first base surface BS-F1 and the second base surface BS-F2 of the base substrate W-BS.

In the window WM of an embodiment, the concave portion HP may be defined in the first base surface BS-F1 of the base substrate W-BS. The concave portion HP may be a portion formed corresponding to the folding portion W-FP. That is, the concave portion HP may be defined on the first base surface BS-F1 so as to overlap the folding portion W-FP. The concave portion HP may be defined on the first base surface BS-F1 of the base substrate W-BS, and may be defined to be concavely recessed in a direction from the first base surface BS-F1 to the second base surface BS-F2 of the base substrate W-BS.

The resin layer RL may be disposed within the concave portion HP defined in the folding portion W-FP of the window WM. The resin layer RL may be disposed, filling the concave portion HP. The resin layer RL may include a material having a refractive index value that matches a refractive index of the base substrate W-BS. The concave portion HP defined in the folding portion W-FP of the window WM may be filled with the resin layer RL, thereby mitigating quality degradation caused by the concave portion HP and enhancing mechanical strength in the folding portion W-FP.

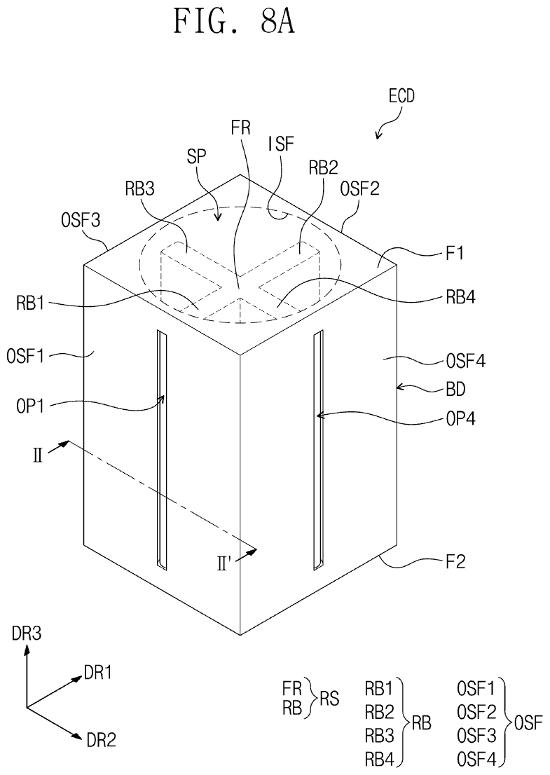

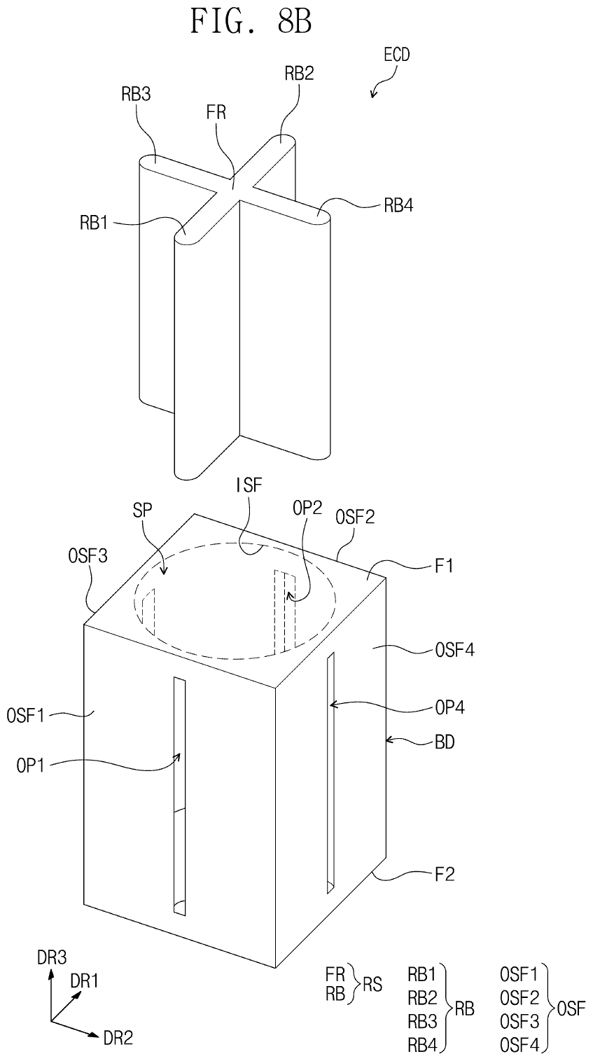

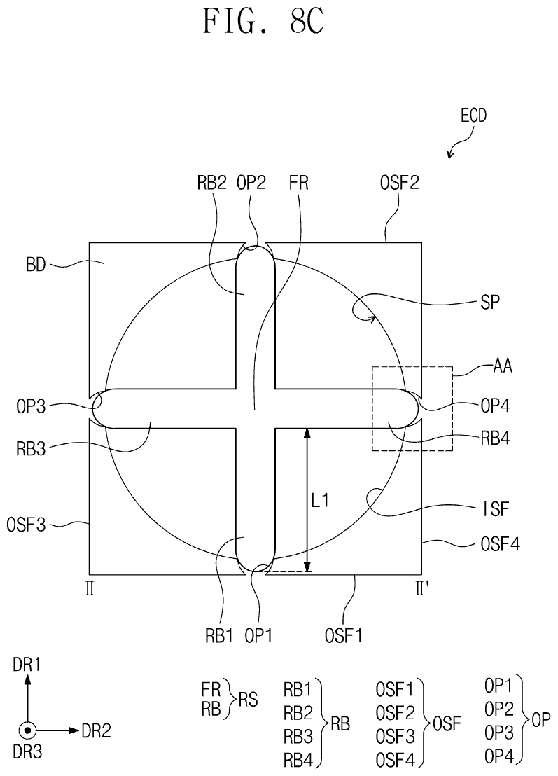

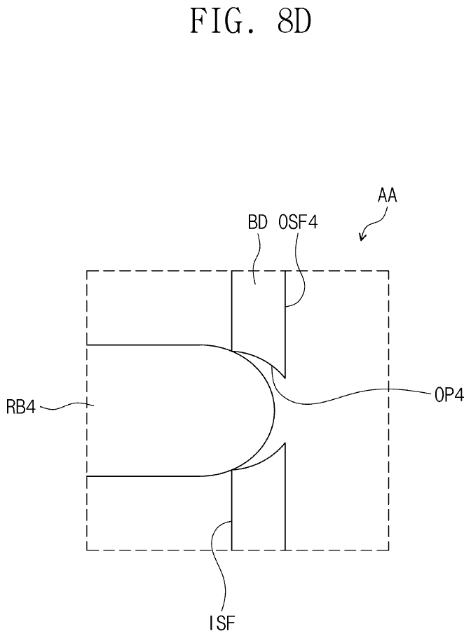

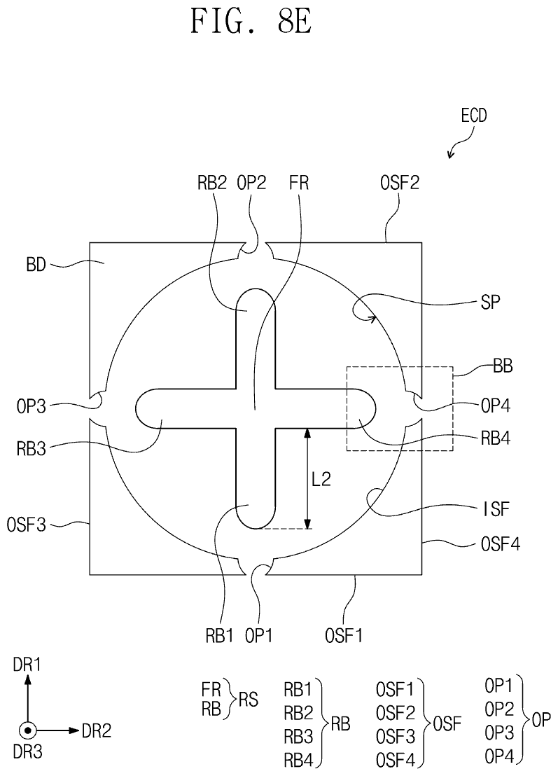

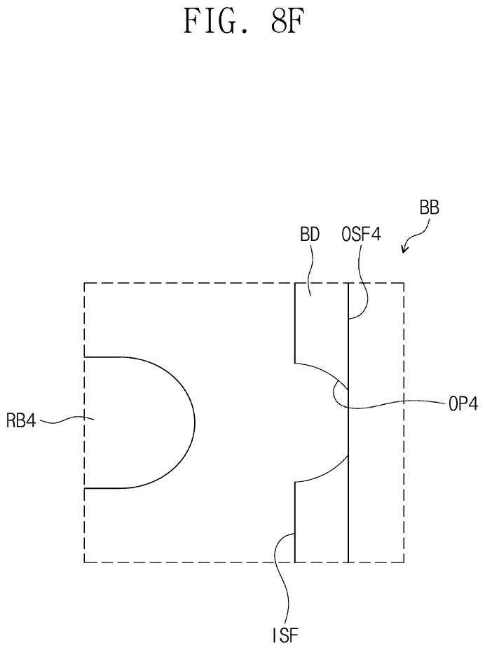

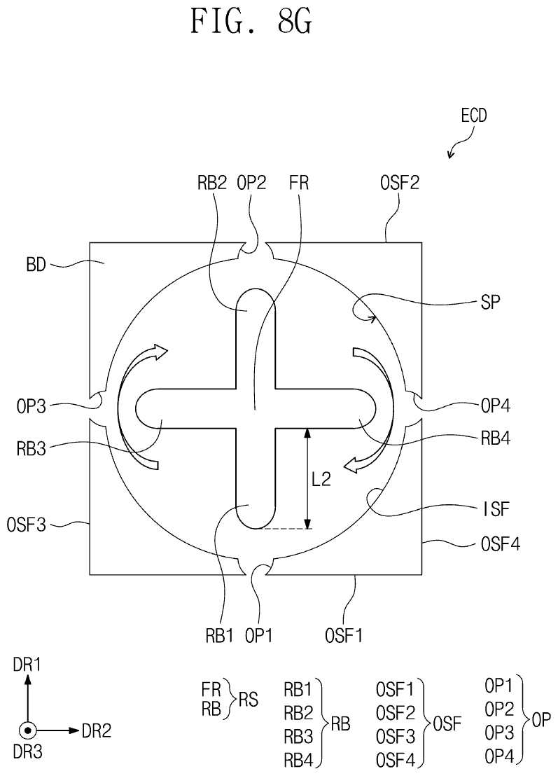

The concave portion HP may be defined on the first base surface BS-F1 of the base substrate W-BS through a slimming process. In the slimming process, a chemical polishing method or the like may be used. In an embodiment, the concave portion HP may be formed through slimming processing using an etching device ECD (see FIG. 8A) described below. The concave portion HP may be formed by slimming processing one surface of the base substrate W-BS using the etching device ECD (see FIG. 8A) described below.

In an embodiment, a portion of the base substrate W-BS in which the concave portion HP is defined may be thinner than other portions. That is, in an embodiment, in the base substrate W-BS, a first average thickness t_{FP} of a portion corresponding to the folding portion W-FP may be less than a second average thickness t_{NP} of a portion corresponding to the non-folding portions W-NFP1 and W-NFP2. The window WM of an embodiment may include the base substrate W-BS which is relatively thinner in the portion corresponding to the folding portion W-FP than in the portion corresponding to the non-folding portions W-NFP1 and W-NFP2, and thus, may have good folding properties.

Referring to FIG. 6B, the base substrate W-BS may include a first base portion WBP1 corresponding to the folding portion W-FP, a second base portion WBP2 corresponding to the non-folding portion W-NFP1 and W-NFP2, and a third base portion WBP3 disposed between the first base portion WBP1 and the second base portion WBP2. The third base portion WBP3 may be a portion whose thickness increases in a direction from the first base portion WBP1 to the second base portion WBP2. In an embodiment, an average thickness of the first base portion WBP1 may be less than an average thickness of the second base portion WBP2.

In an embodiment, the first base portion WBP1 and the third base portion WBP3 may be portions corresponding to the folding portion W-FP. In the base substrate W-BS, the first base portion WBP1 may correspond to a flat portion where the first base surface BS-F1 is parallel to the second base surface BS-F2. The third base portion WBP3 may correspond to a portion where the first base surface BS-F1 is an inclined surface. The concave portion HP formed on the first base surface BS-F1 adjacent to the resin layer RL in the base substrate W-BS may be defined by the first base portion WBP1 and the third base portion WBP3. As described above, the resin layer RL may fill the concave portion HP. The resin layer RL may be in contact with each of the first base portion WBP1 and the third base portion WBP3.

In a cross-section parallel to a plane defined by the first direction DR1 and the third direction DR3, the first base surface BS-F1 corresponding to the third base portion WBP3 may have a linear shape connecting the first base portion WBP1 and the first base surface BS-F1 corresponding to the second base portion WBP2. In an embodiment, the concave portion HP may be defined by the first base surface BS-F1 corresponding to the first base portion WBP1 and the first base surface BS-F1 corresponding to the third base portion WBP3. However, the embodiment of the invention is not limited thereto, and unlike what is shown in FIG. 6B, one surface of the third base portion WBP3 defining the concave portion HP may have a curved surface shape.

The shape of the concave portion HP defined in the base substrate W-BS is not limited to what is shown in FIGS. 6A and 6B. the shape of the concave portion HP may be variously modified by appropriately adjusting the thickness of the first base portion WBP1 and the second base portion WBP2, or the inclination angle of the third base portion WBP3.

The resin layer RL may be a filling layer that fills the concave portion HP. The resin layer RL may be disposed to overlap the folding portion W-FP. The resin layer RL may non-overlap the non-folding portions W-NFP1 and W-NFP2. The resin layer RL may be disposed on one surface of the base substrate W-BS corresponding to the folding portion W-FP. The resin layer RL may be disposed on one surface of the base substrate W-BS where the concave portion HP is defined, and may not be disposed on one surface of the base substrate W-BS where the concave portion HP is not defined.

The resin layer RL may be a layer formed of an organic material. The resin layer RL may include a siloxane-based compound, an acrylate-based compound, a urethane-based compound, or an epoxy-based compound. The resin layer RL may be a layer formed of a polymer material. However, the embodiment of the invention is not limited thereto, and the resin layer RL may further include an inorganic material. The resin layer RL included in the window WM may be optically transparent. Various materials may be included to increase the strength of the resin layer RL within a range in which the optical properties of the resin layer RL are maintained.

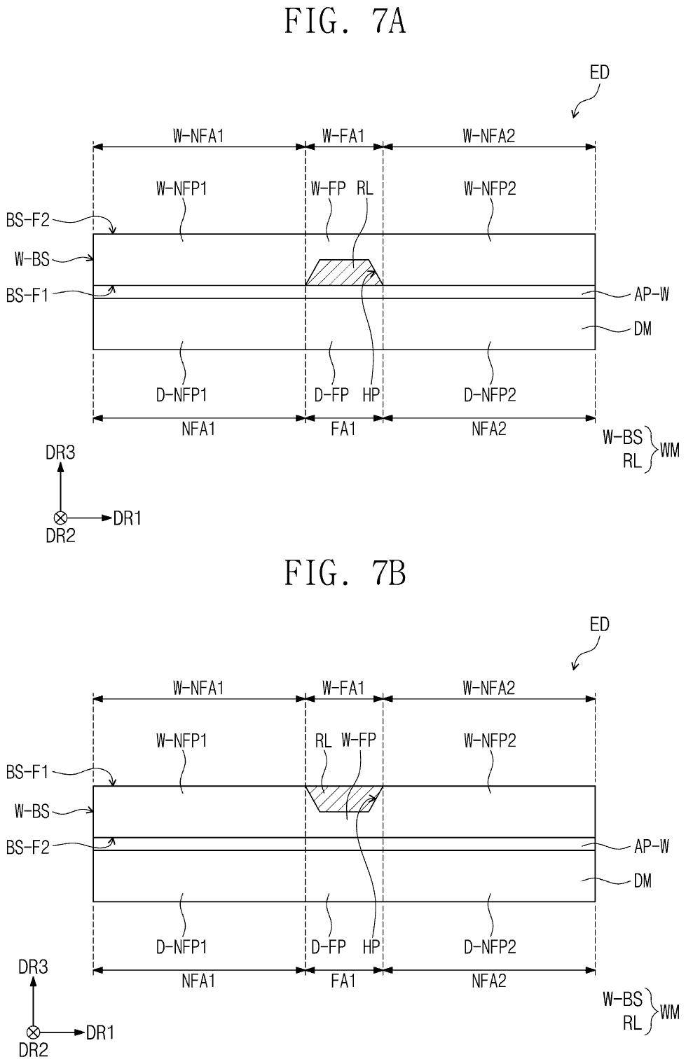

FIGS. 7A and 7B are each views schematically showing a cross-section of one component included in a display device ED according to an embodiment. FIGS. 7A and 7B schematically show only the components of the display module DM, the window adhesive layer AP-W, and the window WM of the display device ED.

Referring to FIG. 7A, in the window WM of an embodiment, the first base surface BS-F1 of the base substrate W-BS may be positioned closer to the display module DM than the second base surface BS-F2. In the window WM of an embodiment, the base substrate W-BS may be disposed such that the first base surface BS-F1 in which the concave portion HP is defined is positioned closer to the display module DM than the second base surface BS-F2. The first base surface BS-F1 may be disposed to be adjacent to the display module DM, and the second base surface BS-F2 may be disposed to face the first base surface BS-F1 in the third direction DR3 and be spaced apart from the display module DM. In the display device ED of an embodiment, the second base surface BS-F2 may be exposed to the outside. In addition, in the display device ED of an embodiment, the resin layer RL may be disposed to be adjacent to the display module DM.

When the display device ED of an embodiment shown in FIG. 7A is in-folded as in the operation of FIG. 1B, the second base surface BS-F2 of the base substrate W-BS corresponding to the first non-folding portion W-NFP1 and the second base surface BS-F2 of the base substrate W-BS corresponding to the second non-folding portion W-NFP2 may be folded to be adjacent, facing each other. In addition, when the display device ED of an embodiment shown in FIG. 7A is out-folded as in the operation of FIG. 1C, the second base surface BS-F2 of the base substrate W-BS corresponding to the first non-folding portion W-NFP1 and the second base surface BS-F2 of the base substrate W-BS corresponding to the second non-folding portion W-NFP2 may be exposed to the outside.

The display device ED shown in FIG. 7B is the one different from the display device ED shown in FIG. 7A in the arrangement direction of the window WM. The display device ED shown in FIG. 7B is the one in which the second base surface BS-F2 of the base substrate W-BS is disposed closer to the display module DM than the first base surface BS-F1, compared to the display device ED shown in FIG. 7A.

Referring to FIG. 7B, in the window WM of an embodiment, the second base surface BS-F2 of the base substrate W-BS may be positioned closer to the display module DM than the first base surface BS-F1. In the window WM of an embodiment, the base substrate W-BS may be disposed such that the second base surface BS-F2 in which the concave portion HP is not defined is positioned closer to the display module DM than the first base surface BS-F1 in which the concave portion HP is defined. The second base surface BS-F2 may be disposed to be adjacent to the display module DM, and the first base surface BS-F1 may be disposed to face the second base surface BS-F2 in the third direction DR3 and be spaced apart from the display module DM. In the display device ED of an embodiment, the resin layer RL may be disposed to be spaced apart from the display module DM.

In the display device ED of an embodiment shown in FIG. 7B, the resin layer RL may be exposed to the outside. However, the embodiment of the invention is not limited thereto, and the window WM of an embodiment may further include an additional protection layer disposed on the first base surface BS-F1 of the base substrate W-BS. In this case, the additional protection layer may be disposed on the first base surface BS-F1 of the base substrate W-BS and the resin layer RL. The resin layer RL may be disposed between the base substrate W-BS and the additional protection layer. The additional protection layer may overlap all of the first non-folding portion W-NFP1, the folding portion W-FP, and the second non-folding portion W-NFP2 of the base substrate W-BS.

When the display device ED of an embodiment shown in FIG. 7B is in-folded as in the operation of FIG. 1B, the first base surface BS-F1 of the base substrate W-BS corresponding to the first non-folding portion W-NFP1 and the first base surface BS-F1 of the base substrate W-BS corresponding to the second non-folding portion W-NFP2 may be folded to be adjacent, facing each other. In addition, when the display device ED of an embodiment shown in FIG. 7B is out-folded as in the operation of FIG. 1C, the first base surface BS-F1 of the base substrate W-BS corresponding to the first non-folding portion W-NFP1 and the first base surface BS-F1 of the base substrate W-BS corresponding to the second non-folding portion W-NFP2 may be exposed to the outside.

Referring to FIGS. 7A and 7B, in the display device ED of an embodiment, the window WM may include a first window non-folding region W-NFA1, a second window non-folding region W-NFA2, and a window folding region W-FA1 disposed between the first window non-folding region W-NFA1 and the second window non-folding region W-NFA2. The first window non-folding region W-NFA1 and the second window non-folding region W-NFA2 may be spaced apart in the first direction DR1 with the window folding region W-FA1 therebetween. The window folding region W-FA1 may be a portion corresponding to the folding region FA1 of the display device ED, the first window non-folding region W-NFA1 may be a portion corresponding to the first non-folding region NFA1 of the display device ED, and the second window non-folding region W-NFA2 may be a portion corresponding to the second non-folding region NFA2 of the display device ED.

FIGS. 8A to 8G are views showing a component of an etching device according to an embodiment of the invention. FIG. 8A is a perspective view of an etching device according to an embodiment of the invention. FIG. 8B is an exploded perspective view of an etching device according to an embodiment of the invention. FIG. 3 shows an exploded perspective view of an etching device according to an embodiment shown in FIG. 8A as an example. FIGS. 8C, 8E, and 8G are each cross-sectional views taken along line II-II′ of FIG. 8A. FIGS. 8A to 8F are each cross-sectional views showing a portion of an etching device according to an embodiment of the invention. FIG. 8D is a cross-sectional view showing a portion corresponding to region AA of FIG. 8C. FIG. 8F is a cross-sectional view showing a portion corresponding to region BB of FIG. 8E.

FIG. 8C is a view showing a first state of an etching device according to an embodiment of the invention, FIG. 8E is a view showing a second state of an etching device according to an embodiment of the invention, and FIG. 8G is a view showing a third state of an etching device according to an embodiment of the invention. The first to third states of the etching device of an embodiment will be described later.

Referring to FIGS. 8A to 8G, an etching device ECD according to an embodiment of the invention includes a container BD and a rotating structure RS. The etching device ECD may be referred to as an “etching unit”.

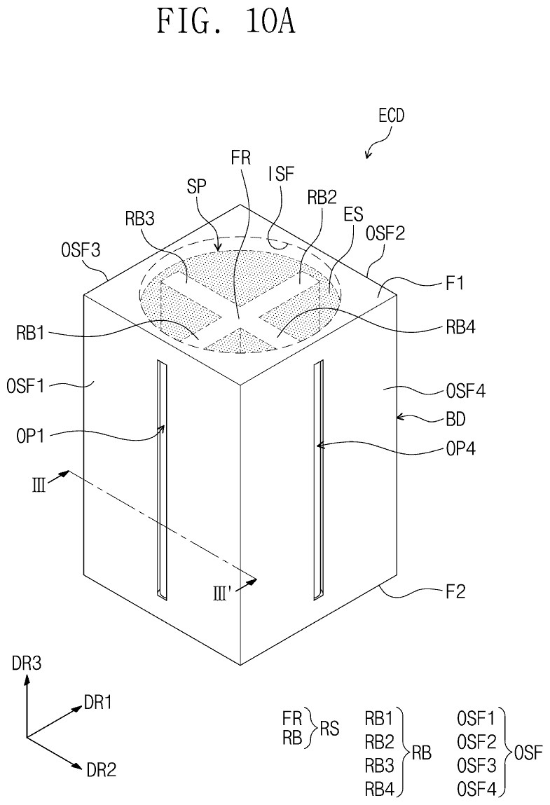

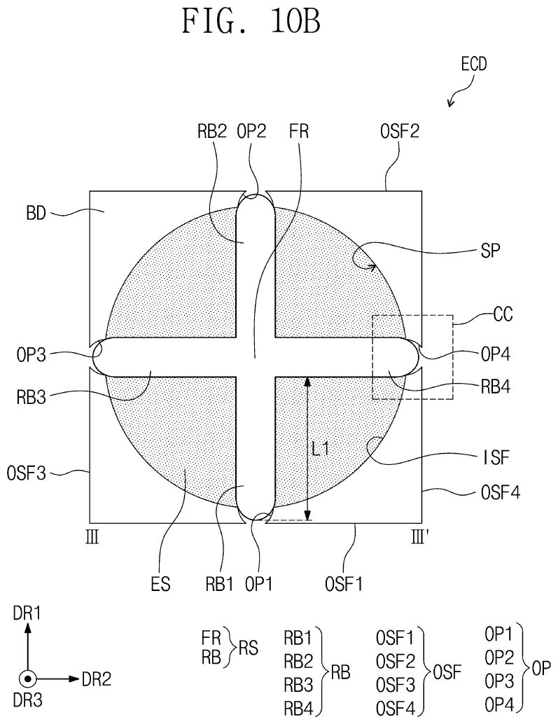

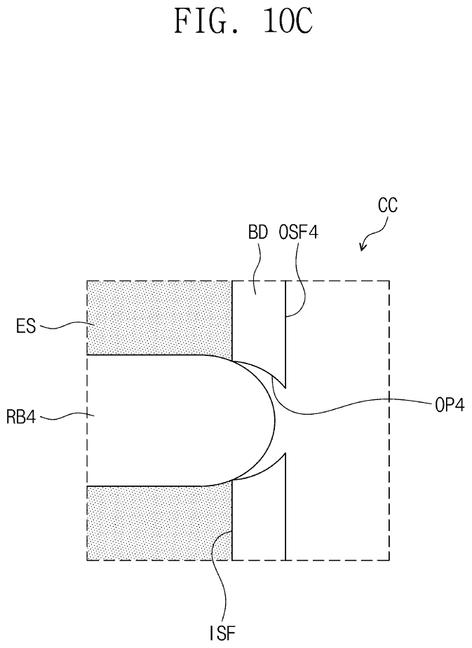

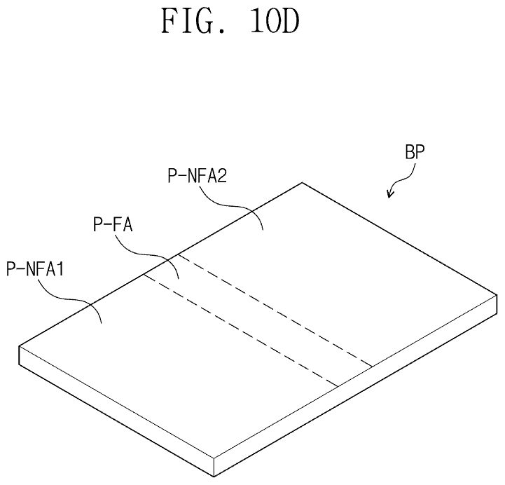

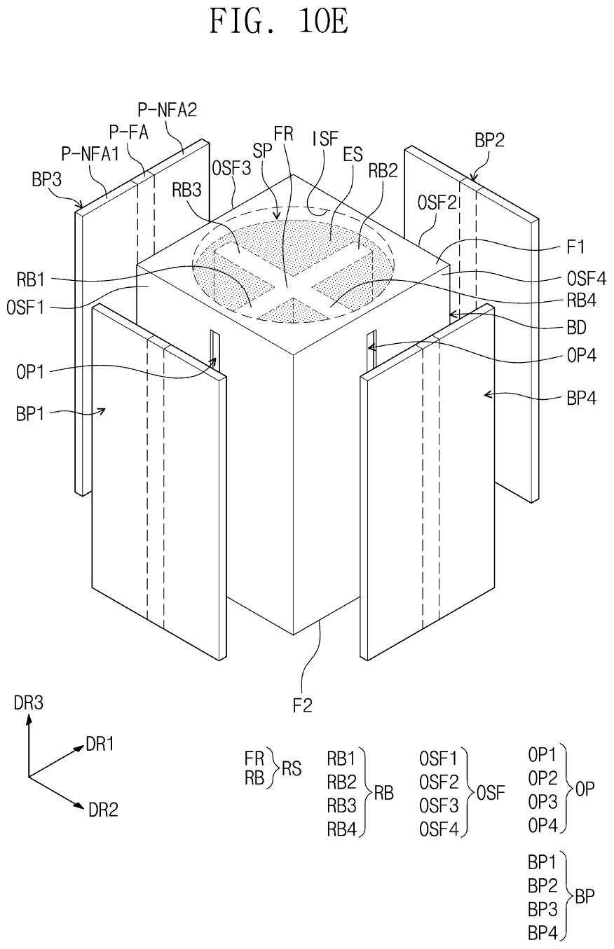

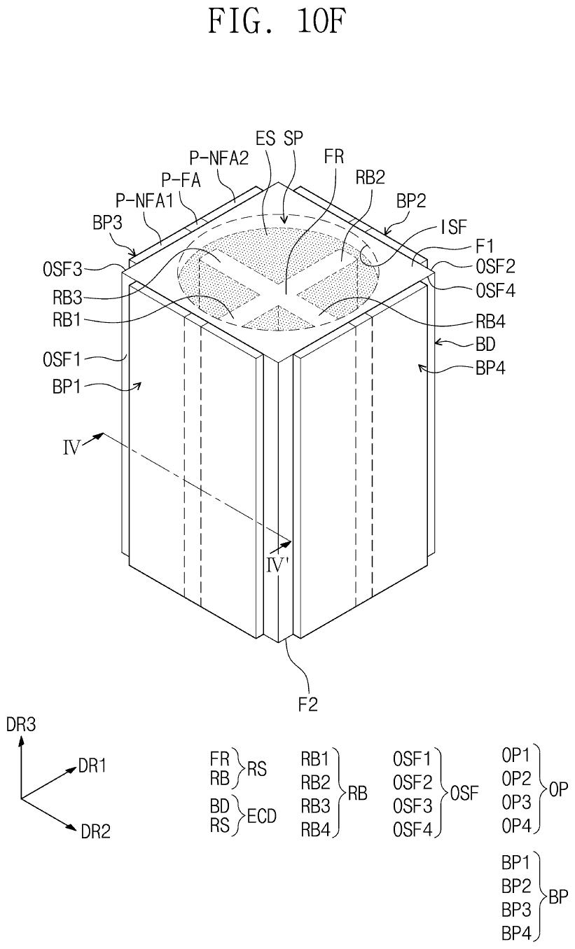

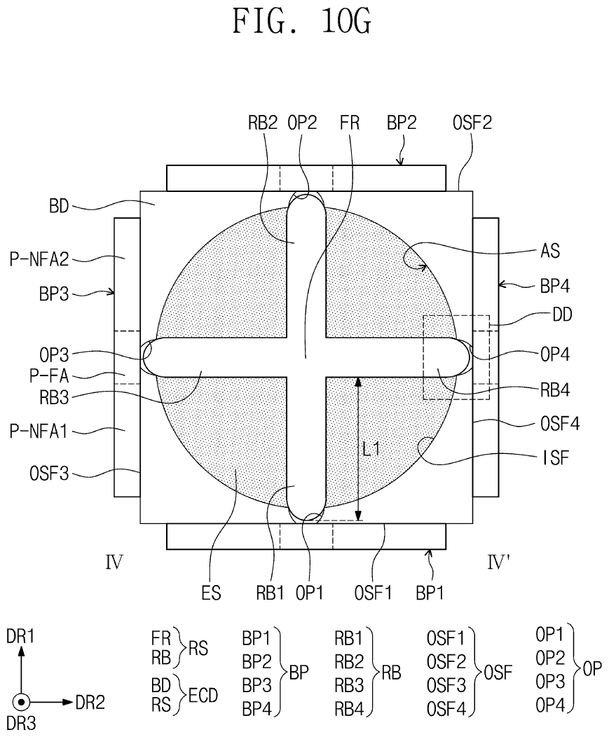

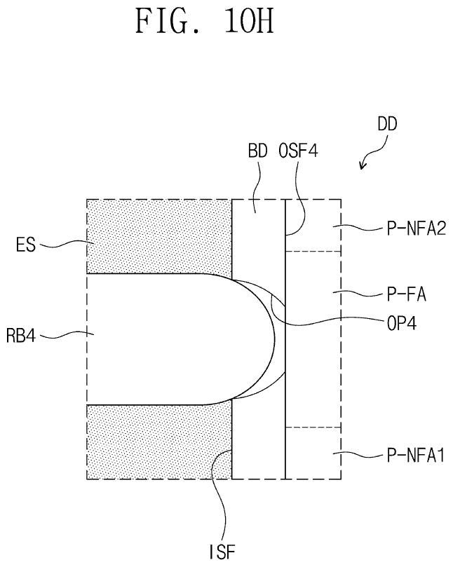

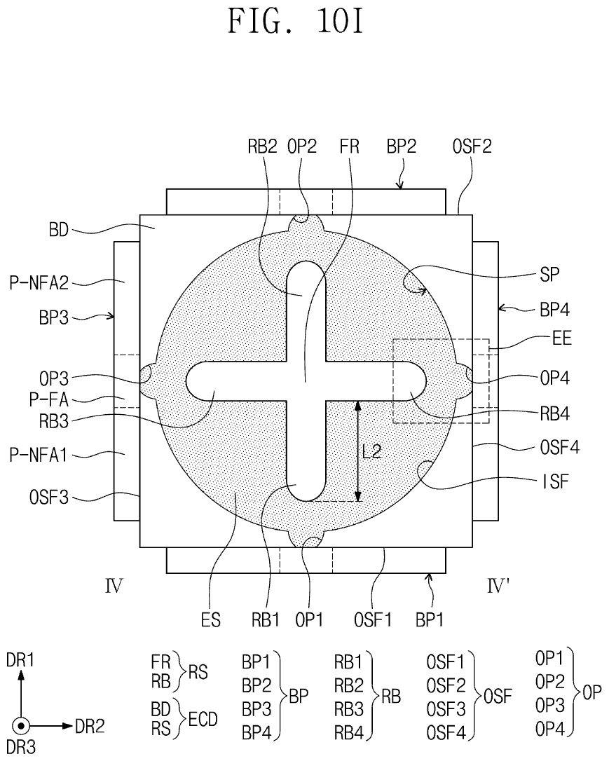

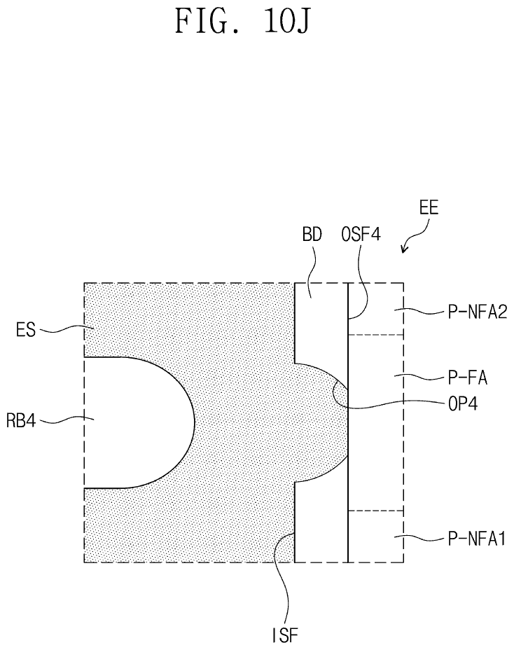

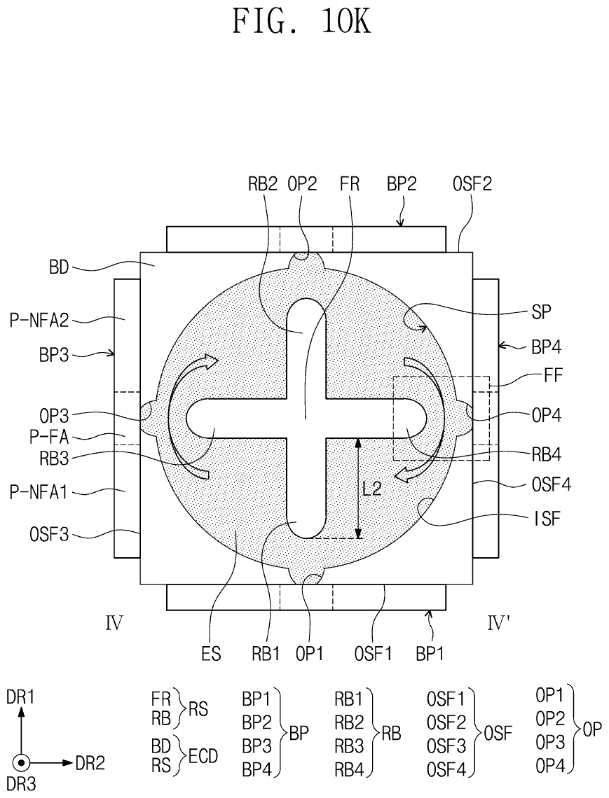

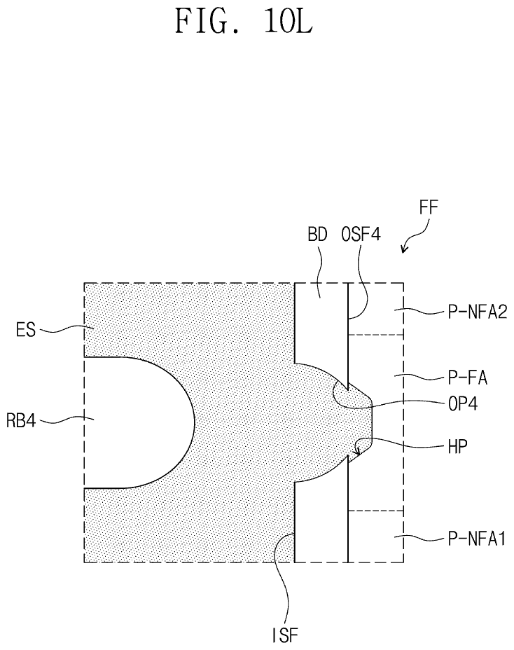

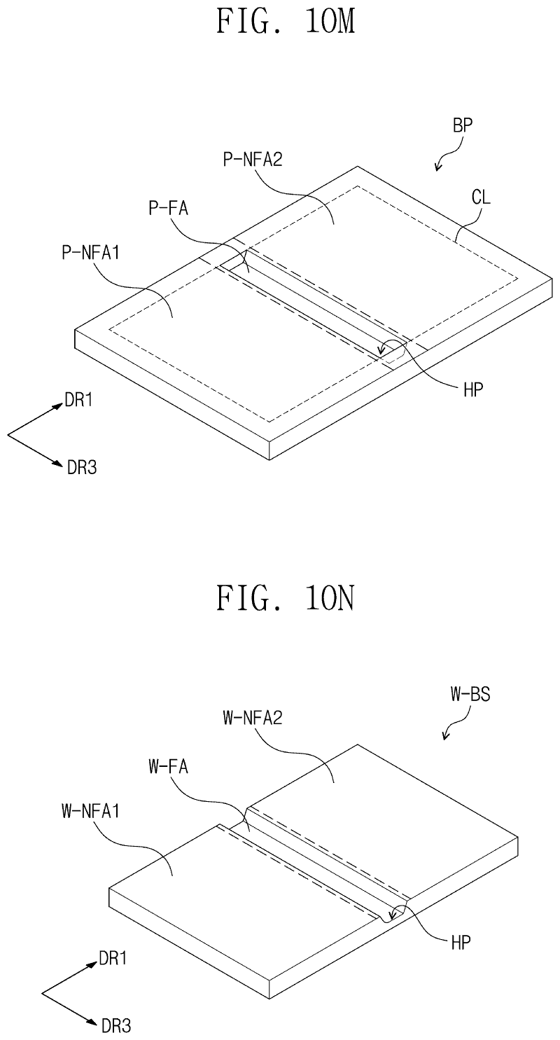

The container BD may include a first surface F1, a second surface F2 opposing the first surface F1, and an outer surface OSF connecting the first surface F1 and the second surface F2. The outer surface of the container BD may also be referred to as a “side surface” of the container BD. The outer surface OSF of the container BD may provide a mounting surface on which a target substrate BP (see FIGS. 10E and 10F) is mounted. FIGS. 8A and 8B are top perspective views of a container BD schematically showing the inside of the container BD.

The outer surface OSF of the container BD may include a plane parallel to the target substrate BP (see FIGS. 10E and 10F). The outer surface OSF of the container BD may be a plane parallel to the target substrate BP (see FIGS. 10E and 10F). FIGS. 8A to 8G show, as an example, that the container BD includes four outer surfaces OSF on which four target substrates BP (see FIGS. 10E and 10F) are mounted, but the embodiment of the invention is not limited thereto. Unlike FIGS. 8A to 8G, the container BD may include three or five or more outer surfaces OSF. That is, the outer surface OSF of the container BD may have a polygonal shape rather than a square shape in a plan view. As used herein, the “plan view” is a view in a direction (i.e., third direction DR3) in which a rotating shaft FR extends.

A receiving space SP for containing an etching solution ES (see FIG. 10A) may be formed inside the container BD. The container BD may include an inner surface ISF defining the receiving space SP. The inner surface ISF of the container BD may define the receiving space SP and may be in contact with the etching solution ES (see FIG. 10A). The receiving space SP may have a cylindrical shape. The receiving space SP may have a cylindrical shape extending in a direction toward the second side F2 from the first side F1 of the container BD. The receiving space SP may have a cylindrical shape extending in the third direction DR3.

In a plan view, the inner surface ISF of the container BD may have a circular shape. However, the embodiment of the invention is not limited thereto, and in another embodiment, the inner surface ISF of the container BD may have an elliptical or rectangular shape in a plan view. For easy rotational motion of a rotating blade RB, the inner surface ISF of the container BD may have a circular or elliptical shape.

At least one opening OP is defined in the container BD. The opening OP may be defined as passing through the outer surface OSF and the inner surface ISF. The opening OP may be defined as passing through the container BD in a direction toward the inner surface ISF from the outer surface OSF. The opening OP may be provided to be openable and closable through a rotating structure RS described below. The opening OP may be provided to be openable and closable through the rotating blade RB included in the rotating structure RS. The rotating blade RB may be engaged with the opening OP to close the opening OP, or may be separated from the opening OP to open the opening OP.

When the opening OP is engaged with the rotating blade RB to close the opening OP, the etching solution ES (see FIG. 10A) provided in the container BD may not leak out to the outside. In addition, when the opening OP is separated from the rotating blade RB to open the opening OP, the etching solution ES (see FIG. 10A) provided in the container BD may be opened to the outside through the opening OP. In this case, the etching solution ES (see FIG. 10A) may come into contact with the target substrate (BP, see FIGS. 10E and 10F) disposed on the outer surface of the container BD through the open opening OP.

The rotating blade RB and the opening OP mat be engaged by any detachable coupling method. For example, the rotating blade RB may be inserted into and fixed in the opening OP. The rotating blade RB may include one end adjacent to the opening OP and a coupling portion which is an end point that is connected to the opening OP, with a width increasing from the end toward the rotating shaft FR. A width of one end of the rotating blade RB adjacent to the opening OP may be less than a width of the opening OP, and a width of the coupling portion may be formed to be the same as a width of the opening OP, and thus the rotating blade RB may be inserted with an outer surface thereof in close contact with at least a portion of an inner surface of the opening OP. Accordingly, the rotating blade RB may be inserted into and fixed to the opening OP due to strong frictional force applied between the rotating blade RB and the opening OP. In this case, to prevent a space from being formed between the opening OP and the rotating blade RB, at least a portion of the outer surface of the rotating blade RB or the inner surface of the opening OP may be covered with an elastic material, but the embodiment of the invention is not limited thereto. In addition, the way that the rotating blade RB and the opening OP are engaged is not limited to what is described above, and various coupling methods may be used without limitation.

The rotating structure RS may be disposed inside the container BD. The rotating structure RS may include a rotating shaft FR and a rotating blade RB. The rotating shaft FR may extend in one direction. The rotating shaft FR may extend in a direction toward the second surface F2 from the first surface F1. The rotating shaft FR may extend in the third direction DR3. The direction to which the rotating shaft FR extends may be parallel to a direction to which the opening OP extends.

The rotating blade RB may be provided to be rotatable around the rotating shaft FR. The rotating blade RB may be provided to be engageable with the opening OP. The rotating blade RB may extend from the rotating shaft FR toward the inner surface ISF of the container BD. The rotating blade RB may be provided to be adjustable in length in an extending direction. The rotating blade RB may be provided to shorten or lengthen an overall length along the extending direction. As used herein, the “extending direction” of the rotating blade RB is a direction from one end of the rotating blade RB adjacent to the opening OP to the other end of the rotating blade RB that contacts the rotating shaft FR in a plan view. Although not shown, the etching device ECD may further include a length-adjusting member (not shown) for adjusting the length of the rotating blade RB. The length-adjusting member (not shown) may adjust the length of the rotating blade RB according to the control of a driving unit (not shown). The length-adjusting member (not shown) may be provided as a spring or an elastic body, but length-adjusting methods are not limited thereto.

The rotating blade RB may be provided to be rotatable within the container BD. The rotating blade RB may cause a vortex within the container BD through rotational motion, and the vortex may affect the flow of the etching solution ES (see FIG. 10A) that comes into contact with the target substrate BP (see FIGS. 10E and 10F). Controlling the rotational speed of the rotating blade RB, the target substrate BP (see FIGS. 10E and 10F) may be regulated in etching degree and etching speed. The rotational motion of the rotating blade RB may induce a steady flow of the etching solution ES (see FIG. 10A) to etch a portion of the target substrate BP (see FIGS. 10E and 10F).

Although not shown, the etching device ECD may further include a driving unit (not shown) serving to control the length and rotational motion of the rotating blade RB. The driving unit (not shown) may adjust the length of the rotating blade RB to regulate a distance between the rotating blade RB and the opening OP. In addition, the driving unit (not shown) may adjust the rotational speed of the rotating blade RB. The driving unit (not shown) may control the rotational speed of the rotating blade RB to regulate the etching degree and etching speed of the target substrate BP (see FIGS. 10E and 10F).

In an embodiment, n openings OP are defined in the container BD, and the rotating structure RS may include n rotating blades RB corresponding to the n openings OP. In this case, n may be an integer of 2 or greater. For example, n may be 2 to 8. For example, n may be 4. Each of the n rotating blades RB is provided to be length-adjustable in the extending direction to open and close each corresponding opening OP.

As shown in FIGS. 8A to 8G, four openings OP1, OP2, OP3, and OP4 are defined in the container BD, and the rotating structure RS may include four sub-rotating blades RB1, RB2, RB3, and RB4 corresponding to the four openings OP1, OP2, OP3, and OP4. Specifically, the openings OP may include a first opening OP1 corresponding to a first outer surface OSF1, a second opening OP2 corresponding to a second outer surface OSF2, a third opening OP3 corresponding to a third outer surface OSF3, and a fourth opening OP4 corresponding to a fourth outer surface OSF4. The rotating blade RB may include a first sub-rotating blade RB1 corresponding to the first opening OP1, a second sub-rotating blade RB2 corresponding to the second opening OP2, a third sub-rotating blade RB3 corresponding to the third opening OP3, and a fourth sub-rotating blade RB4 corresponding to the fourth opening OP4. The first to fourth sub-rotating blades RB1, RB2, RB3, and RB4 may be provided to be length-adjustable in the extending direction to open and close the first to fourth openings OP1, OP2, OP3, and OP4, respectively.

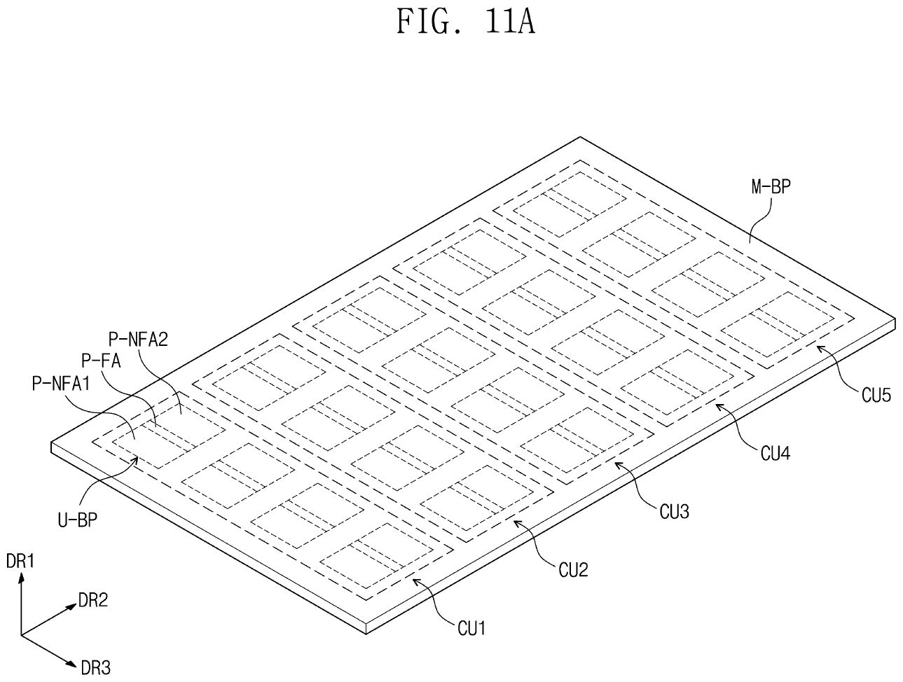

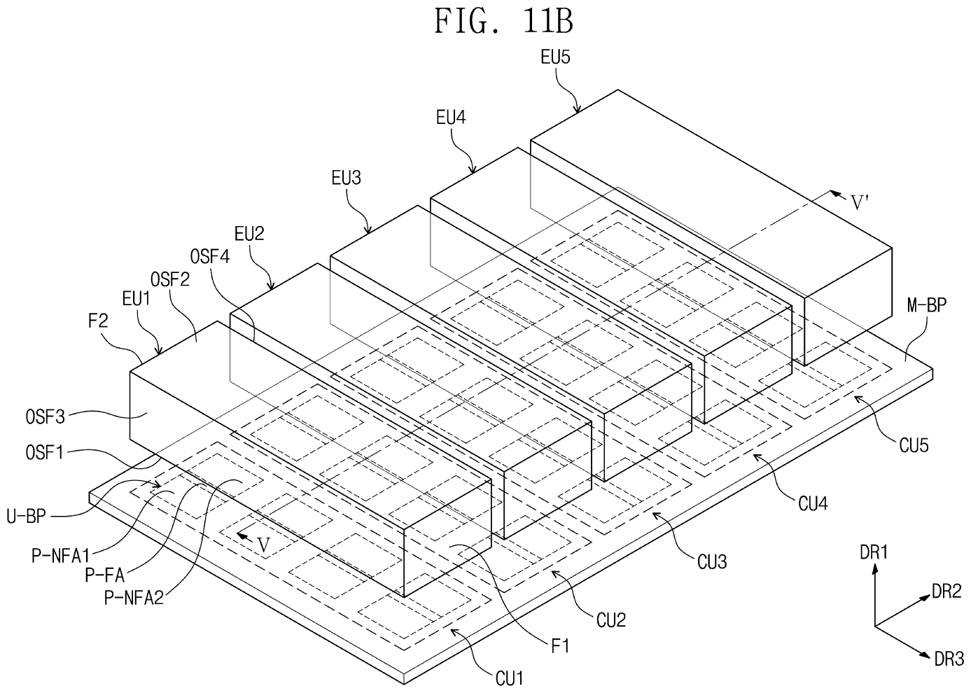

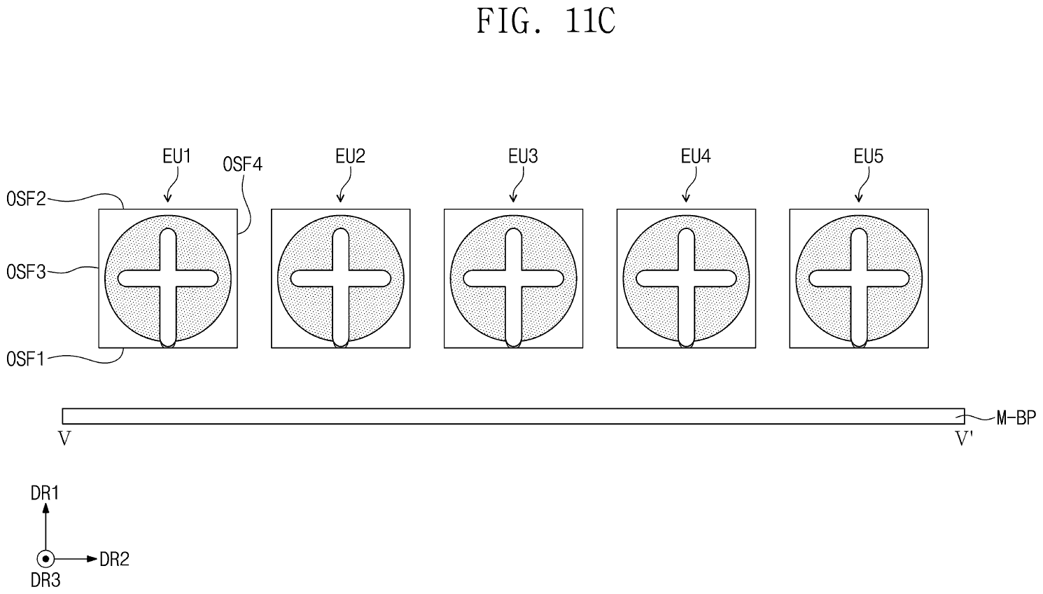

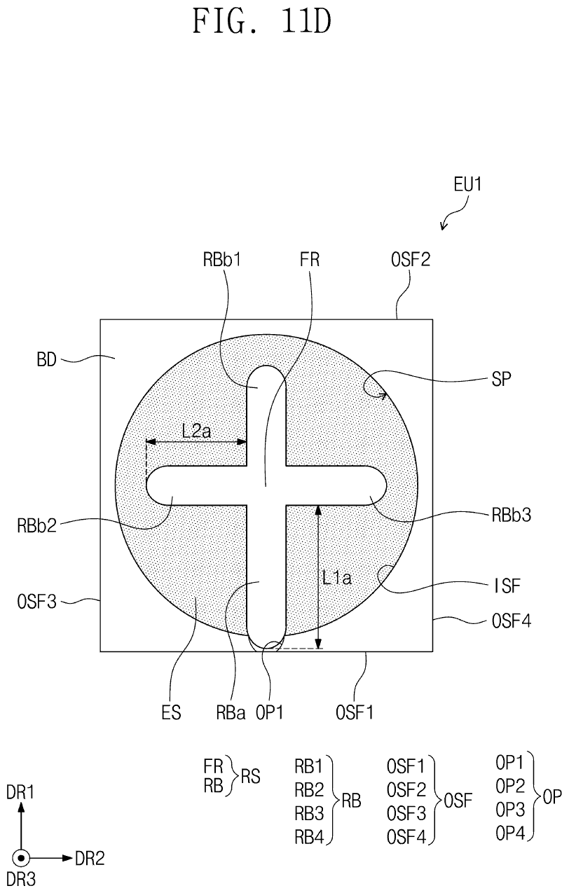

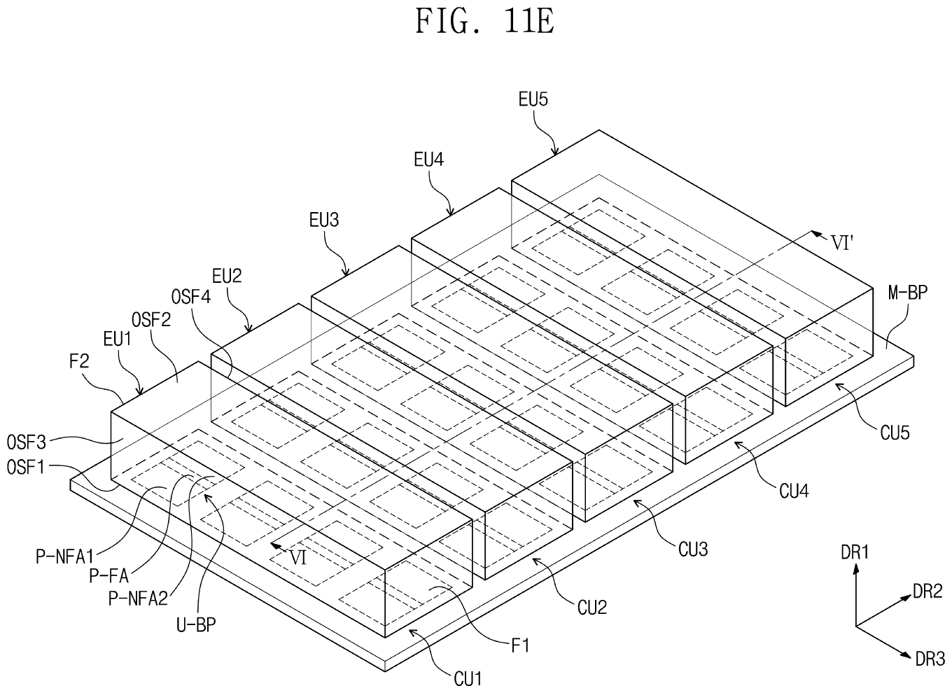

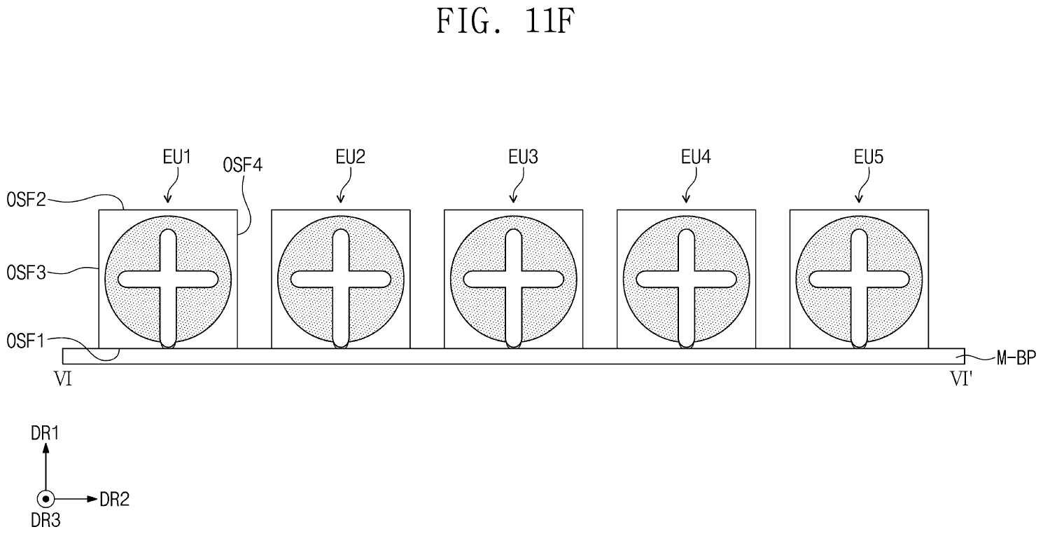

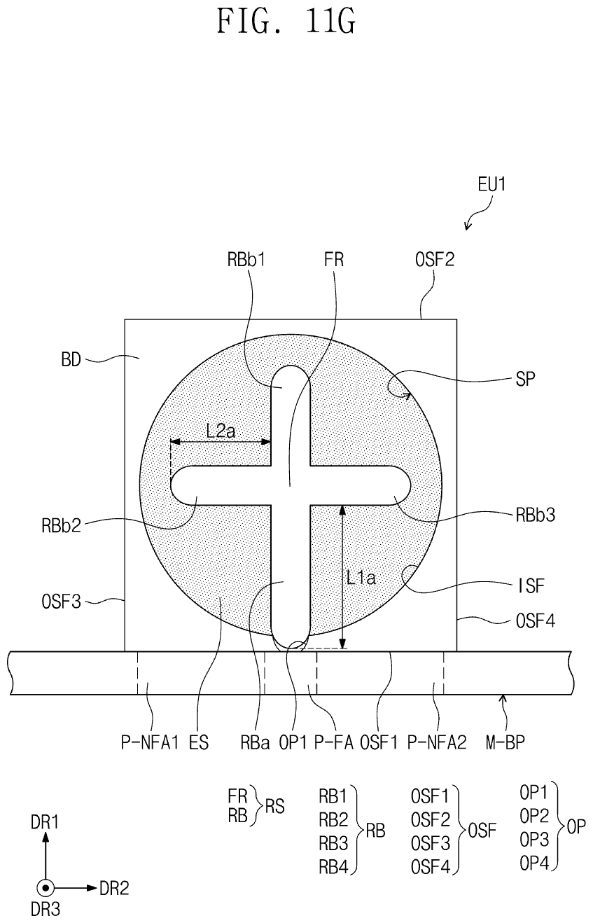

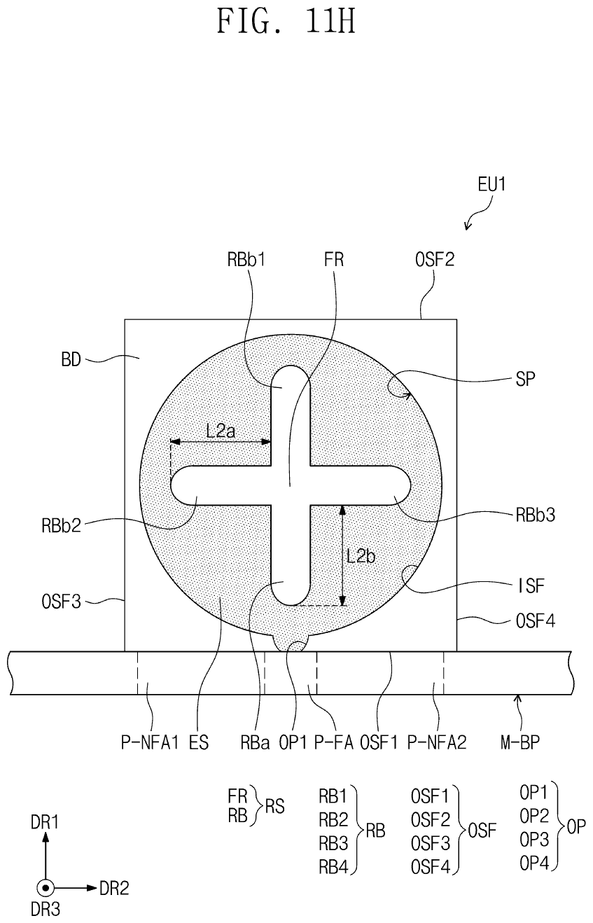

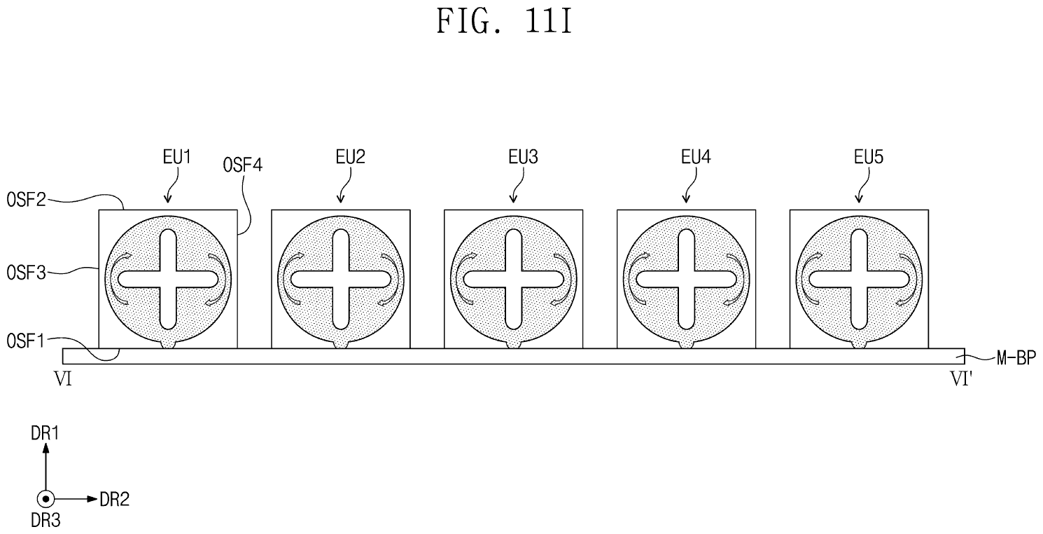

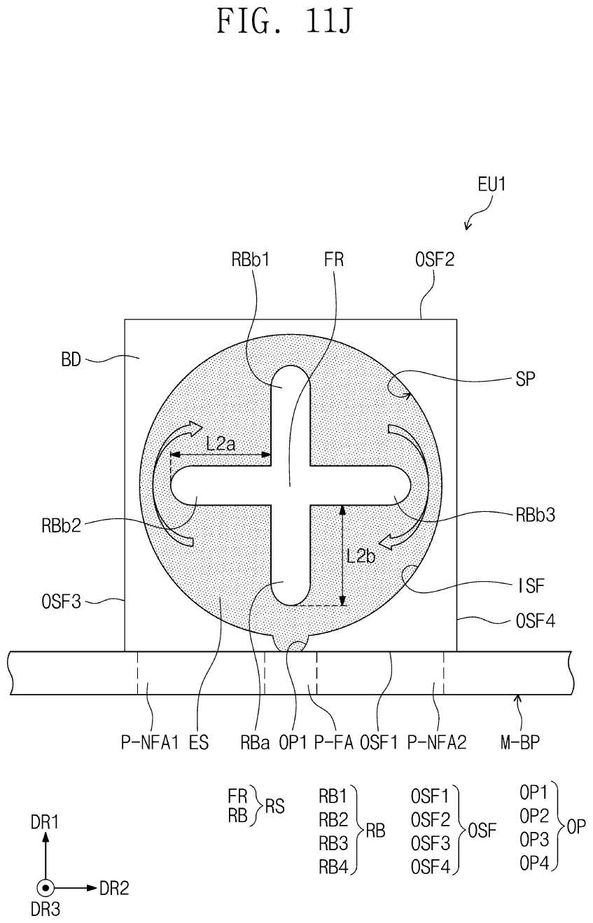

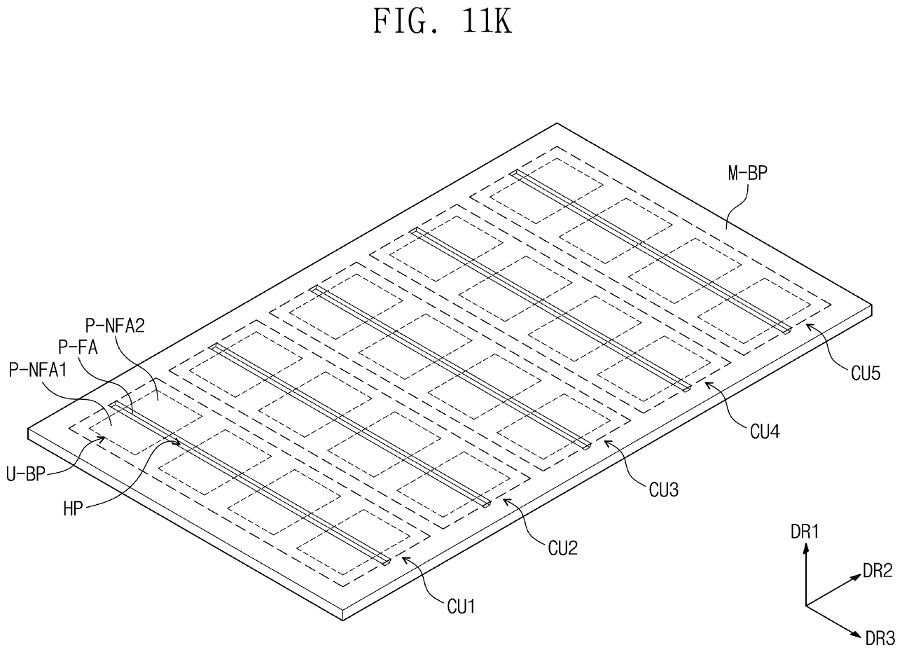

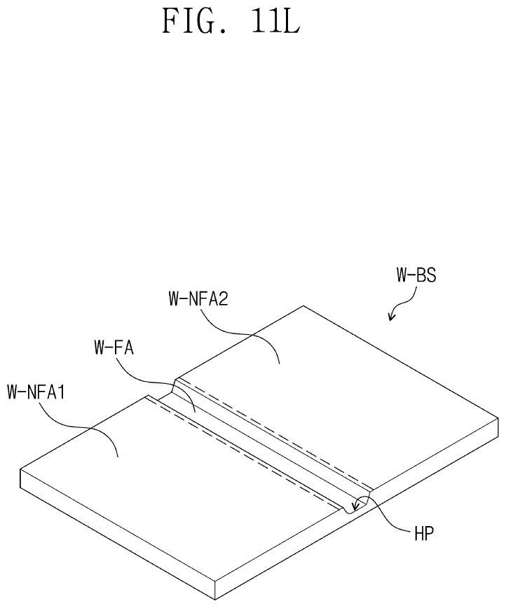

In addition, unlike what is shown in FIGS. 8A to 8G, in another embodiment (See FIG. 11D), the container BD may have m openings defined therein, and the rotating structure RS may include m+a rotating blades. In this case, among the m+a rotating blades, m rotating blades may correspond to the m openings. That is, the m rotating blades may be provided to be length-adjustable to open and close the m openings. In an embodiment, m may be an integer of 1 or greater, and “a” may be an integer of 0 or greater. For example, m may be an integer of 1 to 8, and “a” may be an integer of 0 to 7. In an embodiment, m may be 1, and “a” may be 3. For example, as in the etching device ECD used in a method for manufacturing a window which will be described later in FIGS. 11A to 11L, the container BD may have one opening OP1 defined therein, and the rotating structure RS may include four rotating blades RBa, RBb1, RBb2, and RBb3. The rotating structure RS may include a first rotating blade RBa corresponding to one opening OP1 and a second rotating blade RBb excluding the first rotating blade RBa. The second rotating blade RBb may indicate three rotating blades RBb1, RBb2, and RBb3 excluding the first rotating blade RBa. In an embodiment, the first rotating blade RBa may be provided to be length-adjustable to open and close the first opening OP1. This will be described later.

Referring back to FIGS. 8A to 8G, the rotating structure RS may include first to third states. The first to third states of the rotating structure RS may be determined according to the length and/or the rotational motion of the rotating blade RB, and the etching device ECD may be configured to be deformable between the first to third states through user operation or mechanical operation.

The first state of the rotating structure RS may indicate the state of the rotating structure RS shown in FIGS. 8C and 8D. As shown in FIGS. 8C and 8D, the first state of the rotating structure RS may indicate a state in which the rotating blade RB is engaged with the opening OP. In the first state of the rotating structure RS, the rotating blade RB may be engaged with the opening OP, and the opening OP may be closed by the rotating blade RB. That is, the first state may indicate a closed state in which the opening OP is engaged with the rotating blade RB. In an embodiment, in the first state, the rotating blade RB may have a first length L1 in the extending direction. In this case, the length of the rotating blade RB may indicate a length in a direction to which the rotating blade RB extends. That is, the length of the rotating blade RB may indicate a length from one end of the rotating blade RB adjacent to the opening OP to the other end of the rotating blade RB that starts to extend from the rotating shaft FR in a plan view.

The second state of the rotating structure RS may indicate the state of the rotating structure RS shown in FIGS. 8E and 8F. As shown in FIGS. 8E and 8F, the second state of the rotating structure RS may indicate a state in which the rotating blade RB is separated from the opening OP. In the second state of the rotating structure RS, the rotating blade RB may be separated from the opening OP, and the opening OP may be opened. That is, the second state may indicate an opened state in which the opening OP is completely separated from the rotating blade RB. In an embodiment, in the second state, the rotating blade RB may have a second length L2. The second length L2 of the rotating blade RB in the second state may be less than the first length L1 of the rotating blade RB in the first state.

The third state of the rotating structure RS may indicate the state of the rotating structure RS shown in FIG. 8G. As shown in FIG. 8G, the third state of the rotating structure RS may indicate a state in which the rotating blade RB rotates around the rotating shaft FR while being separated from the opening OP. In an embodiment, the rotating blade RB in the third state may have a second length L2. The second length L2 of the rotating blade RB in the third state may be less than the first length L1 of the rotating blade RB in the first state. The second length L2 of the rotating blade RB in the third state may be equal to the second length L2 of the rotating blade RB in the second state.

Hereinafter, with reference to FIGS. 8A to 8G, an etching device ECD including a container BD in which four openings OP1, OP2, OP3, and OP4 are defined will be described in detail.

With reference to FIGS. 8A to 8G, the container BD may have a rectangular parallelepiped shape. As shown in FIGS. 8A and 8B, the container BD may include a first surface F1, a second surface F2 opposing the first surface F1, and first to fourth outer surfaces OSF1, OSF2, OSF3, and OSF4 connecting the first surface F1 and the second surface F2. The receiving space SP defined within the container BD may have a cylindrical shape. The receiving space SP may have a cylindrical shape extending from the first surface F1 to the second surface F2 of the container BD.

In a plan view, the outer surface OSF of the container BD may have a rectangular shape. The four openings OP1, OP2, OP3, and OP4 corresponding to the first to fourth outer surfaces OSF1, OSF2, OSF3, and OSF4 may be defined in the container BD. However, the embodiment of the invention is not limited thereto. For another example, the container BD may define an opening OP therein corresponding to only some of the first to fourth outer surfaces OSF1, OSF2, OSF3, and OSF4. Alternatively, unlike what is shown in FIGS. 8A to 8G, the container BD may have a polygonal shape having three or five or more outer surfaces in a plan view, and an opening OP may be defined to correspond to each outer surface.

Referring to FIG. 8C, in an embodiment, the container BD may include the first to fourth outer surfaces OSF1, OSF2, OSF3, and OSF4. The first outer surface OSF1 and the second outer surface OSF2 may oppose in the first direction DR1, and the third outer surface OSF3 and the fourth outer surface OSF4 may oppose in the second direction DR2. The opening OP defined in the container BD may be defined to correspond to each of the first to fourth outer surfaces OSF1, OSF2, OSF3, and OSF4. For example, the opening OP may include a first opening OP1 corresponding to the first outer surface OSF1, a second opening OP2 corresponding to the second outer surface OSF2, a third opening OP3 corresponding to the third outer surface OSF3, and a fourth opening OP4 corresponding to the fourth outer surface OSF4. Each of the first to fourth openings OP1, OP2, OP3, and OP4 may be defined as passing through the container BD in a direction toward the inner surface ISF from the corresponding outer surfaces OSF1, OSF2, OSF3, and OSF4.

The rotating structure RS may include a rotating shaft FR extending in one direction (i.e., third direction DR3) and rotating blades RB1, RB2, RB3, and RB4 each extending from the rotating shaft FR and being rotatable around the rotating shaft FR. The rotating blades RB1, RB2, RB3, and RB4 may include a first sub-rotating blade RB1 corresponding to the first opening OP1, a second sub-rotating blade RB2 corresponding to the second opening OP2, a third sub-rotating blade RB3 corresponding to the third opening OP3, and a fourth sub-rotating blade RB4 corresponding to the fourth opening OP4. The first to fourth sub-rotating blades RB1, RB2, RB3, and RB4 are provided to be length-adjustable in the extending direction to open and close the first to fourth openings OP1, OP2, OP3, and OP4, respectively.

A window etching device of an embodiment includes a container containing an etching solution and a rotating structure disposed within the container and including a rotating blade. In the etching device of an embodiment, an opening is defined in the container containing the etching solution, and accordingly, a specific region of a target substrate may be easily etched through the opening. In addition, the rotating blade is provided to be length-adjustable within the container to serve to adjust etching degree through rotational motion and also to selectively open and close an opening. The etching device of an embodiment includes the container and the rotating structure including a rotating blade, may thus have the effect of easily etching a window through a simple process. A method for manufacturing a window using the etching device of an embodiment may exhibit both enhanced process reliability and increased process efficiency.

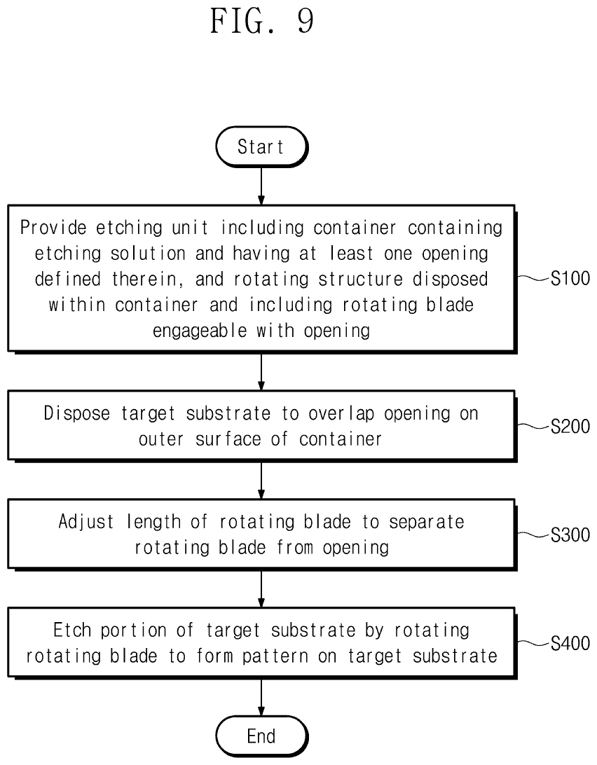

Hereinafter, the method for manufacturing a window of an embodiment will be described with reference to FIGS. 9 and 10A to 10N. The method for manufacturing a window which will be described hereinafter corresponds to a method for manufacturing a window using the etching device according to an embodiment described above. Hereinafter, in the description of the method for manufacturing a window of an embodiment, duplicated descriptions as those described for the etching device of an embodiment above will not be provided again, and different features will be mainly described.

FIG. 9 is a flowchart showing a method for manufacturing a window according to an embodiment of the invention.

Referring to FIG. 9, the method for manufacturing a window includes providing an etching unit including a container containing an etching solution and having at least one opening defined therein, and a rotating structure disposed within the container and including a rotating blade engageable with the opening (S100), disposing a target substrate to overlap the opening on an outer surface of the container (S200), adjusting the length of the rotating blade to separate the rotating blade from the opening (S300), and etching a portion of the target substrate by rotating the rotating blade to form a pattern on the target substrate (S400).

In the display device ED of an embodiment described above in FIGS. 1A to 7B, the base substrate W-BS included in the window WM may be prepared through the method for manufacturing a window using the etching device described above. That is, a pattern HP defined in the base substrate W-BS included in the window WM may be formed through the method for manufacturing a window using the etching device described above.

FIGS. 10A to 10N are views showing some processes in a method for manufacturing a window according to an embodiment of the invention. FIGS. 10A to 10N show a process of manufacturing a base substrate W-BS among the components of a window WM of an embodiment using an etching device according to an embodiment of the invention.

FIGS. 10A to 10C show providing an etching device ECD, FIGS. 10D to 10H show disposing a target substrate BP on an outer surface OSF of a container BD, FIGS. 10I and 10J show adjusting the length of a rotating blade RB to separate the rotating blade RB from an opening OP, and FIGS. 10K and 10L show rotating the rotating blade RB to etch a portion of the target substrate BP. FIGS. 10M and 10N show cutting the partially etched target substrate BP to form a base substrate W-BS. FIG. 10B is a cross-sectional view taken along line III-III′ of FIG. 10A. FIG. 10C is a view showing a portion corresponding to region CC of FIG. 10B. FIGS. 10G, 10I, and 10K are each cross-sectional views taken along line IV-IV′ of FIG. 10F. FIG. 10H is a view showing a portion corresponding to region DD of FIG. 10G. FIG. 10J is a view showing a portion corresponding to region EE of FIG. 10I. FIG. 10L is a view showing a portion corresponding to region FF of FIG. 10K. FIGS. 10A, 10E, and 10F are top perspective views of a container BD schematically showing the inside of the container BD.

Referring to FIGS. 10A to 10C, the method for manufacturing a window according to an embodiment may include providing an etching device ECD. The etching device ECD included in the method for manufacturing a window according to an embodiment may be the same as the etching device ECD described above in FIGS. 8A to 8G. The etching device ECD may include a container BD containing an etching solution ES and having at least one opening OP defined therein, and a rotating structure RS including a rotating blade RB disposed within the container BD and provided to be engageable with the opening OP. An outer surface of the container BD in which the opening OP is defined may provide a mounting surface on which the target substrate BP (see FIG. 10D) is mounted. The rotating blade RB may be provided to be length-adjustable in an extending direction to open and close the opening OP.

Referring to FIGS. 10B and 10C, the rotating structure RS may be in a first state prior to the disposing of the target substrate BP (see FIG. 10D). That is, first to fourth rotating blades RB1, RB2, RB3, and RB4 included in the rotating structure RS may be engaged with first to fourth openings OP1, OP2, OP3, and OP4, respectively. In the first state, each of the first to fourth rotating blades RB1, RB2, RB3, and RB4 may have a first length L1.

A first sub-rotating blade RB1 may be engaged with the first opening OP1 to close the first opening OP1 from the outside. A second sub-rotating blade RB2 may be engaged with the second opening OP2 to close the second opening OP2 from the outside. A third sub-rotating blade RB3 may be engaged with the third opening OP3 to close the third opening OP3 from the outside. A fourth sub-rotating blade RB4 may be engaged with the fourth opening OP4 to close the fourth opening OP4 from the outside. The first to fourth openings OP1, OP2, OP3, and OP4 are closed through the first to fourth sub-rotating blades RB1, RB2, RB3, and RB4, respectively, and accordingly, the etching solution ES provided inside the container BD may not leak out to the outside.

Referring to FIGS. 10D to 10H, the disposing of the target substrate BP on the outer surface OSF of the container BD may be performed.

The target substrate BP may correspond to the base substrate W-BS (see FIG. 6A) before the pattern HP (see FIG. 6A) is formed on the window WM (see FIG. 6A). The target substrate BP may include a first non-folding region P-NFA1, a second non-folding region P-NFA2, and a folding region P-FA disposed between the first non-folding region P-NFA1 and the second non-folding region P-NFA2. In the target substrate BP, the first non-folding region P-NFA1 may be a portion corresponding to the first non-folding portion W-NFP1 (see FIG. 6A) of the base substrate W-BS (see FIG. 6A) included in the window WM (see FIG. 6A) described above, the second non-folding region P-NFA2 may be a portion corresponding to the second non-folding portion W-NFP2 (see FIG. 6A) of the base substrate W-BS (see FIG. 6A), and the folding region P-FA may be a portion corresponding to the folding portion W-FP (see FIG. 6A) of the base substrate W-BS (see FIG. 6A).

In the etching device ECD, the outer surface OSF of the container BD may provide a mounting surface on which the target substrate BP is disposed. The outer surface OSF of the container BD in which the opening OP is defined may be in contact with the target substrate BP. The target substrate BP may be provided as a single unit or a plurality of units depending on the number of the openings OP. For example, as shown in FIGS. 10E and 10F, the container BD may have first to fourth openings OP1, OP2, OP3, and OP4 defined therein, and first to fourth target substrates BP1, BP2, BP3, and BP4 may be disposed on first to fourth outer surfaces OSF1, OSF2, OSF3, and OSF4 of the container BD to correspond to first to fourth openings OP1, OP2, OP3, and OP4, respectively.

The first target substrate BP1 may be disposed on the first outer surface OSF1 to correspond to the first opening OP1. The second target substrate BP2 may be disposed on the second outer surface OSF2 to correspond to the second opening OP2. The third target substrate BP3 may be disposed on the third outer surface OSF3 to correspond to the third opening OP3. The fourth target substrate BP4 may be disposed on the fourth outer surface OSF4 to correspond to the fourth opening OP4.

When viewed in the first direction DR1, the first target substrate BP1 may overlap the first opening OP1, and the second target substrate BP2 may overlap the second opening OP2. In addition, when viewed in the second direction DR2, the third target substrate BP3 may overlap the third opening OP3, and the fourth target substrate BP4 may overlap the fourth opening OP4. The target substrates BP1, BP2, BP3, and BP4 overlap the corresponding openings OP1, OP2, OP3, and OP4, and thus even when the openings OP1, OP2, OP3, and OP4 are opened through the rotating blades RB1, RB2, RB3, and RB4 thereafter, the etching solution ES may not leak out to the outside.

In the disposing of the target substrate BP, the opening OP may overlap the folding region P-FA of the target substrate BP. The first opening OP1 may overlap the folding region P-FA of the first target substrate BP1, the second opening OP2 may overlap the folding region P-FA of the second target substrate BP2, the third opening OP3 may overlap the folding region P-FA of the third target substrate BP3, and the fourth opening OP4 may overlap the folding region P-FA of the fourth target substrate BP4.

Although not shown, the etching device ECD of an embodiment may further include a fixing member (not shown) for fixing the target substrate BP. Through the fixing member (not shown), the target substrate BP may be stably fixed in a state of being in close contact with the outer surface OSF of the container BD. Accordingly, the movement of the target substrate BP may be limited, thereby preventing the etching solution ES from leaking out through any gaps between the container BD and the target substrate BP. For example, the fixing member (not shown) may fix the target substrate BP in a manner of pressing the target substrate BP toward the center of the container BD, but the method of the fixing member (not shown) is not limited thereto.

Referring to FIGS. 10I and 10J, after the disposing of the target substrate BP, adjusting the length of the rotating blade RB to separate the rotating blade RB from the opening OP may be performed.

After the disposing of the target substrate BP, the rotating structure RS may turn from the first state to the second state. That is, the first to fourth rotating blades RB1, RB2, RB3, and RB4 included in the rotating structure RS may be separated from the first to fourth openings OP1, OP2, OP3, and OP4, respectively, thereby opening each of the first to fourth openings OP1, OP2, OP3, and OP4 from the outside. In the second state, the first to fourth rotating blades RB1, RB2, RB3, and RB4 may each have a second length L2. The second length L2 of the rotating blade RB in the second state may be less than the first length L1 of the rotating blade RB in the first state.

As the rotating blade RB is separated from the opening OP, the opening OP is opened, and thus the etching solution ES may come into contact with the target substrate BP. That is, in the second state, each of the first to fourth openings OP1, OP2, OP3, and OP4 is opened, and portions of the first to fourth target substrates BP1, BP2, BP3, and BP4 may come into contact with the etching solution ES through the opened first to fourth openings OP1, OP2, OP3, and OP4, respectively. A portion corresponding to the folding region P-FA in each of the first to fourth target substrates BP1, BP2, BP3, and BP4 may come into contact with the etching solution ES.

Referring to FIGS. 10K and 10L, after the separating of the rotating blade RB, etching a portion of the target substrate BP by rotating the rotating blade RB to form a pattern HP on the target substrate BP may be performed.

In the forming of a pattern on the target substrate BP, the rotating structure RS may turn from the second state to the third state. In the third state, each of the first to fourth rotating blades RB1, RB2, RB3, and RB4 may have a second length L2. That is, when turning from the second state to the third state, the lengths of the first to fourth rotating blades RB1, RB2, RB3, and RB4 may not change.

In the third state, the rotating blades RB included in the rotating structure RS may rotate around the rotating shaft FR with the rotating shaft FR as a rotating axis. For example, the rotating blades RB may rotate clockwise or counterclockwise around the rotating shaft FR. The rotating blade RB may cause a vortex within the container BD through rotational motion, and the vortex may affect the flow of the etching solution ES that comes into contact with the target substrate BP. As the rotating blade RB rotates, the etching solution ES may flow at a constant speed, and a portion of the target substrate BP in contact with the target etching solution ES may be etched according to the flow of the etching solution ES. A degree to which the target substrate BP is etched may be controlled by regulating the rotational speed of the rotating blade RB. For example, the degree to which the target substrate BP is etched may be proportional to the rotational speed of the rotating blade RB.

Referring to FIG. 10M, the pattern HP may be formed on the target substrate BP through the etching of a portion of the target substrate BP. A portion of the target substrate BP exposed to the etching solution ES may be etched to form the pattern HP. The pattern HP may be formed in the folding region P-FA of the target substrate BP. The pattern HP may include a groove extending in one direction. The pattern HP may include a groove extending in the third direction DR3. A depth of the groove included in the pattern HP may be less than a thickness of the target substrate BP. The thickness of the target substrate BP may correspond to an average thickness of the first non-folding region P-NFA1 and the second non-folding region P-NFA2 of the target substrate BP.

Referring to FIGS. 10M and 10N together, the method for manufacturing a window according to an embodiment may further include cutting the target substrate BP to provide a base substrate W-BS. The cutting of the target substrate BP along a cutting line CL may be performed after the pattern HP is formed on the target substrate BP. In FIG. 10N, the cutting line CL is shown as a dotted line and may be defined along the border of the target substrate BP. Although not shown, a cutting device (not shown) may be disposed on the target substrate BP, and the cutting device (not shown) may cut the target substrate BP along the cutting line CL. The cutting device (not shown) may be a laser, but the embodiment of the invention is not limited thereto. Through the cutting process, a portion of the target substrate BP in which the pattern HP is not formed may be removed. However, the embodiment of the invention is not limited thereto, and the cutting of the target substrate BP may not be provided depending on process conditions, target substrate area, or opening area design.

Thereafter, the base substrate W-BS provided by the cutting of the target substrate BP may be utilized as the base substrate W-BS included in the window WM of the display device ED (see FIGS. 3 and 4) described above.

FIGS. 11A to 11L are views showing some processes in a method for manufacturing a window according to an embodiment of the invention. FIG. 11C is a cross-sectional view taken along line V-V′ of FIG. 11B. FIGS. 11F and 11I are each cross-sectional views taken along line VI-VI′ of FIG. 11E. FIGS. 11A to 11L show forming a pattern HP (see FIG. 6A) on a base substrate W-BS (see FIG. 6A) among the components of a window WM (see FIG. 6A) of an embodiment using an etching device according to an embodiment of the invention. FIGS. 11A to 11L show a method for manufacturing a window using an etching device of an embodiment to etch a target substrate in sheet unit. Hereinafter, in describing the method for manufacturing a window according to an embodiment with reference to FIGS. 11A to 11L, the same reference numerals are given to components that are the same as the components described above, and detailed descriptions thereof will not be provided.

FIG. 11A is a view showing providing a target substrate. As shown in FIG. 11A, the target substrate M-BP may be a large-area sheet substrate. The target substrate M-BP may be an organic substrate in sheet unit. Referring to FIG. 11A, the target substrate M-BP may include a plurality of unit substrates U-BP. The plurality of unit substrates U-BP may be arranged to be spaced apart from each other.

The plurality of unit substrates U-BP may each correspond to the base substrate W-BS (see FIG. 6A) before the pattern HP (see FIG. 6A) included in the window WM (see FIG. 6A) is formed. The plurality of unit substrates U-BP may each include a first non-folding region P-NFA1, a second non-folding region P-NFA2, and a preliminary folding region P-FA disposed between the first non-folding region P-NFA1 and the second non-folding region P-NFA2. In each of the plurality of unit substrates U-BP, the first non-folding region P-NFA1 may be a portion corresponding to the first non-folding portion W-NFP1 of the base substrate W-BS (see FIG. 6A) included in the window WM (see FIG. 6A) described above, the second non-folding region P-NFA2 may be a portion corresponding to the second non-folding portion W-NFP2 of the base substrate W-BS (see FIG. 6A), and the folding region P-FA may be a portion corresponding to the folding portion W-FP of the base substrate W-BS (see FIG. 6A).

The plurality of unit substrates U-BP included in the target substrate M-BP may be divided into a plurality of unit groups. The target substrate M-BP may include a plurality of unit groups CU1, CU2, CU3, CU4, and CU5, each of which includes n unit substrates U-BP arranged in the third direction DR3. In this case, n may be an integer of 2 or greater. That is, the plurality of unit groups CU1, CU2, CU3, CU4, and CU5 may each include two or more unit substrates U-BP. For example, as shown in FIG. 11A, n may be 4, but the embodiment of the invention is not limited thereto.

The plurality of groups CU1, CU2, CU3, CU4, and CU5 may be arranged to be spaced apart in the second direction DR2. For example, the target substrate M-BP may include the first to fifth unit groups CU1, CU2, CU3, CU4, and CU5, and the first to fifth unit groups CU1, CU2, CU3, CU4, and CU5 may be arranged to be spaced apart along the second direction DR2. FIG. 11A shows, as an example, that the target substrate M-BP includes five groups CU1, CU2, CU3, CU4, and CU5, but the embodiment of the invention is not limited thereto.

Referring to FIGS. 11B to 11F, preparing an etching device ECD may be performed. The etching device ECD may include a plurality of etching units EU1, EU2, EU3, EU4, and EU5 corresponding to a plurality of unit groups CU1, CU2, CU3, CU4, and CU5, respectively. The plurality of etching units EU1, EU2, EU3, EU4, and EU5 may each be disposed on the target substrate M-BP. The plurality of etching units EU1, EU2, EU3, EU4, and EU5 may each be disposed on a corresponding unit group among the plurality of unit groups CU1, CU2, CU3, CU4, and CU5. As shown in FIG. 11B, the etching device ECD may include a first etching unit EU1 disposed to correspond to the first unit group CU1, a second etching unit EU2 disposed to correspond to the second unit group CU2, a third etching unit EU3 disposed to correspond to the third unit group CU3, a fourth etching unit EU4 disposed to correspond to the fourth unit group CU4, and a fifth etching unit EU5 disposed to correspond to the fifth unit group CU5.

The etching device ECD used in the method for manufacturing a window shown in FIGS. 11A to 11L may be different in shape from the etching device ECD used in the method for manufacturing a window shown in FIGS. 10A to 10N. FIGS. 11D, 11G, 11H, and 11J show one of the etching units included in the etching device ECD used in the method for manufacturing a window shown in FIGS. 11A to 11L. Hereinafter, the etching device ECD used in the method for manufacturing a window shown in FIGS. 11A to 11L will be described in detail with reference to FIGS. 11D, 11G, 11H, and 11J.

Referring to FIG. 11D, the etching device ECD according to an embodiment of the invention includes a container BD and a rotating structure RS.

The container BD may provide a receiving space SP containing an etching solution ES. The container BD may have a rectangular parallelepiped shape. The container BD may include a first surface F1, a second surface F2 opposing the first surface F1, and a plurality of outer surfaces OSF1, OSF2, OSF3, and OSF4 connecting the first surface F1 and the second surface F2. The outer surfaces OSF1, OSF2, OSF3, and OSF4 of the container BD may also be referred to as “side surfaces” of the container BD. The receiving space SP defined within the container BD may have a cylindrical shape. The receiving space SP may have a cylindrical shape extending from the first surface F1 to the second surface F2 of the container BD.

The receiving space SP may be defined by an inner surface ISF of the container BD. The inner surface ISF of the container BD may be in contact with the etching solution ES. In a plan view, the inner surface ISF of the container BD may have a circular shape. However, the embodiment of the invention is not limited thereto, and in another embodiment, the inner surface ISF of the container BD may have an elliptical or rectangular shape in a plan view. For easy rotational motion of a rotating blade RB, the inner surface ISF of the container BD may have a circular or elliptical shape.

One opening OP1 may be defined in the container BD. The opening OP1 may be defined to correspond to any one of the plurality of outer surfaces OSF1, OSF2, OSF3, and OSF4 in the container BD. For example, as shown in FIG. 11D, the first opening OP1 may be defined to correspond to the first outer surface OSF1 among the plurality of outer surfaces OSF1, OSF2, OSF3, and OSF4. No opening may be defined in portions corresponding to the second to fourth outer surfaces OSF2, OSF3, and OSF4 excluding the first outer surface OSF1. The first outer surface OSF1 corresponding to the first opening OP1 may be a mounting surface that comes into contact with the target substrate M-BP.

The first opening OP1 may be defined as passing through the outer surface OSF and the inner surface ISF. The opening OP1 may be provided to be openable and closable through the rotating blade RB included in the rotating structure RS. The rotating blade RB may be engaged with the opening OP1 to close the opening OP1 or separated from the opening OP1 to open the opening OP1.

When the first opening OP1 is engaged with the rotating blade RB to be closed, the etching solution ES provided in the container BD may not leak out to the outside. In addition, when the first opening OP1 is separated from the rotating blade RB to be opened, the etching solution ES provided in the container BD may be opened to the outside through the first opening OP1. In this case, the etching solution ES may come into contact with the target substrate M-BP disposed on the outer surface of the container BD through the opened first opening OP1.

The rotating structure RS may be disposed inside the container BD. The rotating structure RS may include a rotating shaft FR and a rotating blade RB. The rotating shaft FR may extend in one direction. The rotating shaft FR may extend in a direction toward the second surface F2 from the first surface F1. The direction to which the rotating shaft FR extends may be parallel to a direction (i.e., third direction DR3) to which the opening OP1 extends.

The rotating blade RB may be provided to be rotatable around the rotating shaft FR. The rotating blade RB may be provided to be engageable with the first opening OP1. The rotating blade RB may extend from the rotating shaft FR toward the inner surface ISF of the container BD.

The rotating blade RB may be provided to be rotatable within the container BD. The rotating blade RB may cause a vortex within the container BD through rotational motion, and the vortex may affect the flow of the etching solution ES that comes into contact with the target substrate M-BP. Controlling the rotational speed of the rotating blade RB, the target substrate M-BP may be regulated in etching degree and etching speed. The rotational motion of the rotating blade RB may induce a steady flow of the etching solution ES to etch a portion of the target substrate M-BP.

The rotating structure RS may include a first rotating blade RBa corresponding to the first opening OP1 and a second rotating blade RBb excluding the first rotating blade RBa. The second rotating blade RBb may indicate three second rotating blades RBb1, RBb2, and RBb3 excluding the first rotating blade RBa. In an embodiment, the first rotating blade RBa may be provided to be length-adjustable to open and close the first opening OP1.

In an embodiment, the rotating structure RS may include first to third states. The first to third states of the rotating structure RS may be determined according to the length and/or the rotational motion of the rotating blades RBa, RBb1, RBb2, and RBb3, and the etching device ECD may be configured to be deformable between the first to third states through user operation or mechanical operation.

The first state of the rotating structure RS may indicate the state of the rotating structure RS shown in FIG. 11D. The first state of the rotating structure RS may indicate a state in which the first rotating blade RBa is engaged with the first opening OP1. In the first state of the rotating structure RS, the first rotating blade RBa may be engaged with the first opening OP1, and the first opening OP1 may be closed through the first rotating blade RBa. That is, the first state may indicate a closed state in which the first opening OP1 is engaged with the first rotating blade RBa.

In an embodiment, in the first state, the first rotating blade RBa may have a first length L1a, and the second rotating blades RBb1, RBb2, and RBb3 may have a second length L2a. In the first state, the second length L2a may be less than the first length L1a. In this case, the length of each of the rotating blades RBa, RBb1, RBb2, and RBb3 may indicate a length in a direction to which each of the rotating blades RBa, RBb1, RBb2, and RBb3 extends. That is, the length of the rotating blades RBa, RBb1, RBb2, and RBb3 may indicate a length from one end of the rotating blades RBa, RBb1, RBb2, and RBb3 adjacent to the inner surface ISF to the other end of the rotating blades RBa, RBb1, RBb2, and RBb3 that starts to extend from the rotating shaft FR with respect to a direction to which the rotating blades RBa, RBb1, RBb2, and RBb3 extends.

The second state of the rotating structure RS may indicate a state of the rotating structure RS shown in FIG. 11H. As shown in FIG. 11H, the second state may indicate a state in which the first rotating blade RBa is separated from the first opening OP1. In the second state of the rotating structure RS, the first rotating blade RBa may be separated from the first opening OP1, and the first opening OP1 may be opened. That is, the second state may indicate that the first opening OP1 is completely separated from the first rotating blade RBa and is in an opened state.

In an embodiment, the first rotating blade RBa may have a second length L2b in the second state. The second length L2b of the first rotating blade RBa in the second state may be less than the first length L1a of the first rotating blade RBa in the first state. In addition, the second length L2b of the first rotating blade RBa in the second state may be the same as the second length L2a of the second rotating blades RBb1, RBb2, and RBb, but is not limited thereto.

The third state of the rotating structure RS may indicate a state of the rotating structure RS shown in FIG. 11J. As shown in FIG. 11J, the third state of the rotating structure RS may indicate a state in which the rotating blades RBa, RBb1, RBb2, and RBb) rotate around the rotating shaft FR. In the state in which the first rotating blade RBa is separated from the first opening OP1, the first and second rotating blades RBa, RBb1, RBb2, and RBb may all rotate around the rotating shaft FR.

In an embodiment, the first rotating blade RBa in the third state may have a second length L2b. The second length L2b of the first rotating blade RBa in the third state may be the same as the second length L2b of the first rotating blade RBa in the second state. In addition, the second length L2b of the first rotating blade RBa in the third state may be the same as the second length L2a of the second rotating blades RBb1, RBb2, and RBb, but is not limited thereto.

Although not shown, the etching device ECD may further include a driving unit (not shown) serving to control the length and/or rotational motion of the rotating blades RBa, RBb1, RBb2, and RBb. The driving unit (not shown) may adjust the length of the first rotating blade RBa to regulate a distance between the first rotating blade RBa and the first opening OP1. In addition, the driving unit (not shown) may adjust the rotational speed of the rotating blades RBa, RBb1, RBb2, and RBb. The driving unit (not shown) may control the rotational speed of the rotating blades RBa, RBb1, RBb2, and RBb to adjust the etching degree and etching speed of the target substrate M-BP.

Referring back to FIGS. 11B to 11D, the rotating structure RS may be in the first state before the disposing of the target substrate M-BP. That is, the first rotating blade RBa included in the rotating structure RS may be engaged with the first opening OP1. In the first state, the first rotating blade RBa may have a first length L1a. The first rotating blade RBa may be engaged with the first opening OP1 to close the first opening OP1 from the outside. The first rotating blade RBa is closed through the first opening OP1, and thus the etching solution ES provided in the container BD may not leak out to the outside.

Referring to FIGS. 11E to 11G, disposing a plurality of etching units EU1, EU2, EU3, EU4, and EU5 on the target substrate M-BP may be performed.

In each of the plurality of etching units EU1, EU2, EU3, EU4, and EU5, among the outer surfaces OSF of the container BD, the first outer surface OSF1 corresponding to the first opening OP1 may be in contact with the target substrate M-BP. The plurality of etching units EU1, EU2, EU3, EU4, and EU5 may each be disposed on the target substrate M-BP such that the first outer surface OSF1 faces the target substrate M-BP. The first outer surface OSF1 corresponding to the first opening OP1 is disposed to face the target substrate M-BP, and thus even when the first opening OP1 is opened through the first rotating blade RBa thereafter, the etching solution ES may not leak out to the outside.

The plurality of etching units EU1, EU2, EU3, EU4, and EU5 may be disposed on a corresponding unit group among the plurality of unit groups CU1, CU2, CU3, CU4, and CU5, respectively. For example, as shown in FIG. 11E, among the plurality of etching units EU1, EU2, EU3, EU4, and EU5, the first etching unit EU1 may be disposed to correspond to the first unit group CU1, the second etching unit EU2 may be disposed to correspond to the second unit group CU2, the third etching unit EU3 may be disposed to correspond to the third unit group CU3, the fourth etching unit EU4 may be disposed to correspond to the fourth unit group CU4, and the fifth etching unit EU5 may be disposed to correspond to the fifth unit group CU5.

The plurality of unit substrates U-BP included in the first unit group CU1 may each overlap the first opening OP1 defined in the first etching unit EU1. The plurality of unit substrates U-BP included in the second unit group CU2 may each overlap the first opening OP1 defined in the second etching unit EU2. The plurality of unit substrates U-BP included in the third unit group CU3 may each overlap the first opening OP1 defined in the third etching unit EU3. The plurality of unit substrates U-BP included in the fourth unit group CU4 may each overlap the first opening OP1 defined in the fourth etching unit EU4. The plurality of unit substrates U-BP included in the fifth unit group CU5 may each overlap the first opening OP1 defined in the fifth etching unit EU5. In the disposing of the plurality of etching units EU1, EU2, EU3, EU4, and EU5 on the target substrate M-BP, the first opening OP1 may overlap the folding region P-FA of the plurality of unit substrates U-BP included in the target substrate M-BP.

Referring to FIG. 11H, after the disposing of the plurality of etching units EU1, EU2, EU3, EU4, and EU5 on the target substrate M-BP, adjusting the length of the first rotating blade RBa to separate the first rotating blade RBa from the first opening OP1 may be performed.

After the disposing of the plurality of etching units EU1, EU2, EU3, EU4, and EU5 on the target substrate M-BP, the rotating structure RS may turn from the first state to the second state. That is, the first rotating blade RBa included in the rotating structure RS may be separated from the first opening OP1 to open the first opening OP1. In the second state, the first rotating blade RBa may have a second length L2b. The second length L2b of the first rotating blade RBa in the second state may be less than the first length L1a of the first rotating blade RBa in the first state.

As the first rotating blade RBa is separated from the first opening OP1, the first opening OP1 is opened, and thus the etching solution ES may come into contact with the target substrate M-BP. That is, in the second state, the first opening OP1 is opened, and a portion of each of the plurality of unit substrates U-BP included in the target substrate M-BP may come into contact with the etching solution ES through the opened first opening OP1. A portion corresponding to the folding region P-FA of each of the plurality of unit substrates U-BP may come into contact with the etching solution ES, and at least a portion of a folding portion P-FP may be etched through the etching solution ES.

Referring to FIGS. 11I to 11L, after the separating of the first rotating blade RBa, etching a portion of the target substrate M-BP by rotating the rotating blades RBa, RBb1, RBb2, and RBb3 to form a pattern HP on the target substrate M-BP may be performed.

In the forming of the pattern HP on the target substrate M-BP, the rotating structure RS may turn from the second state to the third state. In the third state, the first rotating blade RBa may have a second length L2b. That is, when turning from the second state to the third state, the length of the first rotating blade RBa may not change.

In the third state, the first and second rotating blades RBa, RBb1, RBb2, and RBb3 included in the rotating structure RS may rotate around the rotating shaft FR. For example, the first and second rotating blades RBa, RBb1, RBb2, and RBb3 may rotate clockwise or counterclockwise around the rotating shaft FR. The first and second rotating blades RBa, RBb1, RBb2, and RBb3 may cause a vortex within the container BD through rotational motion, and the vortex may affect the flow of the etching solution ES that comes into contact with the target substrate M-BP. As the first and second rotating blades RBa, RBb1, RBb2, and RBb3 rotate, the etching solution ES may flow at a constant speed, and a portion of the target substrate M-BP in contact with the etching solution ES may be etched according to the flow of the etching solution ES. A degree to which the target substrate M-BP is etched may be controlled by regulating the rotational speed of the first and second rotating blades RBa, RBb1, RBb2, and RBb3. For example, a degree to which the target substrate M-BP is etched may be proportional to the rotational speed of the first and second rotating blades RBa, RBb1, RBb2, and RBb3.

Referring to FIGS. 11K and 11L, the pattern HP may be formed on the target substrate M-BP through the etching of a portion of the target substrate M-BP. A portion of the target substrate M-BP exposed to the etching solution ES may be etched to form the pattern HP. The pattern HP may be formed in the folding region P-FA of each of the plurality of unit substrates U-BP included in the target substrate M-BP. The pattern HP may include a groove extending in one direction. That is, the pattern HP may include a groove extending in the third direction DR3. A depth of the groove included in the pattern HP may be less than a thickness of the target substrate BP. The thickness of the target substrate BP may correspond to an average thickness of the first non-folding region P-NFA1 and the second non-folding region P-NFA2 of the target substrate BP.

Referring to FIG. 11L, the method for manufacturing a window according to an embodiment may further include cutting the target substrate M-BP to separate the unit substrates U-BP from the target substrate M-BP. In the separating of the unit substrates U-BP of an embodiment, each of the plurality of unit substrates U-BP may be cut into individual unit substrates U-BP through a cutting device (not shown) from the target substrate M-BP. The cutting device (not shown) may cut the target substrate M-BP along a cutting line CT formed at an edge of the unit substrates U-BP. Therefore, the unit substrates U-BP formed on the target substrate M-BP may be separated into the individual unit substrates U-BP. For example, the cutting device (not shown) may be a laser, but the embodiment of the invention is not limited thereto. Thereafter, the separated unit substrates U-BP may be utilized as the base substrate W-BS included in the window WM of the display device ED (see FIGS. 3 and 4) described above.

According to an embodiment of the invention, a window etching device and a window etching method may effectively process glass using an etchant.

Although the invention has been described with reference to a preferred embodiment of the invention, it will be understood that the invention should not be limited to these preferred embodiments but various changes and modifications may be made by those skilled in the art without departing from the spirit and scope of the invention. Accordingly, the technical scope of the invention is not intended to be limited to the contents set forth in the detailed description of the specification, but is intended to be defined by the appended claims.

What is claimed is:

1. An etching device comprising:
a container configured to contain an etching solution and defining at least one opening therein; and
a rotating structure disposed within the container and including a rotating blade engageable with the at least one opening,
wherein the rotating blade is provided to be adjustable in length in an extending direction.

2. The etching device of claim 1, wherein the rotating structure comprises a rotating shaft extending in one direction, and
the rotating blade extends toward an inner surface of the container from the rotating shaft.

3. The etching device of claim 1, wherein the rotating structure opens and closes the at least one opening by adjusting the length of the rotating blade in the extending direction.

4. The etching device of claim 2, wherein the at least one opening extends in the one direction.

5. The etching device of claim 2, wherein the rotating structure comprises:
a first state in which one end of the rotating blade is engaged with the at least one opening;
a second state in which the one end of the rotating blade is separated from the at least one opening; and
a third state in which the rotating blade rotates around the rotating shaft.

6. The etching device of claim 5, wherein:
in the first state, the rotating blade has a first length in the extending direction,
in the second state, the rotating blade has a second length in the extending direction less than the first length, and
in the third state, the rotating blade has the second length.

7. The etching device of claim 1, wherein the container comprises:
an outer surface on which a target substrate is mounted; and
an inner surface in contact with the etching solution, and
wherein the at least one opening is defined as passing through the outer surface and the inner surface.

8. The etching device of claim 7, wherein the outer surface comprises a plane parallel to the target substrate.

9. The etching device of claim 7, wherein the inner surface of the container defines a receiving space, which contains the etching solution, and
in a plan view, the receiving space has a circular shape.

10. The etching device of claim 1, wherein the at least one opening of the container comprises n openings,
the rotating blade of the rotating structure comprises n rotating blades corresponding to the n openings, and
n is an integer of 2 or greater.

11. The etching device of claim 1, wherein the at least one opening comprises first to fourth openings,
the rotating blade comprises:
a first sub-rotating blade corresponding to the first opening;
a second sub-rotating blade corresponding to the second opening;
a third sub-rotating blade corresponding to the third opening; and
a fourth sub-rotating blade corresponding to the fourth opening, and
the first to fourth sub-rotating blades are provided to be adjustable in the length to open and close the first to fourth openings, respectively.

12. The etching device of claim 1, wherein the at least one opening of the container comprises m openings,
the rotating structure comprises m+a rotating blades,
m rotating blades of the m+a rotating blades correspond to the m openings,
the m rotating blades are provided to be adjustable in the length to open and close the m openings, respectively,
the m is an integer of 1 or greater, and
the a is an integer of 0 or greater.

13. The etching device of claim 12, wherein the m is 1 and the a is 3,
the rotating structure comprises:
a first rotating blade corresponding to the one opening; and
second rotating blades including three other rotating blades excluding the first rotating blade among the m+a rotating blades, and
the first rotating blade is provided to be adjustable in the length to open and close the one opening.

14. A method for manufacturing a window, the method comprising:
preparing an etching unit including a container containing an etching solution and defining at least one opening therein, and a rotating structure disposed within the container and including a rotating blade engageable with the at least one opening;
disposing a target substrate to overlap the at least one opening on an outer surface of the container;
adjusting a length of the rotating blade to separate the rotating blade from the at least one opening; and
etching a portion of the target substrate by rotating the rotating blade to form a pattern on the target substrate.

15. The method of claim 14, wherein a state in which one end of the rotating blade is engaged with the at least one opening is defined as a first state,
and a state in which the one end of the rotating blade is separated from the at least one opening is defined as a second state,
before the disposing of the target substrate, the rotating structure is in the first state, and
after the disposing of the target substrate, the rotating structure turns from the first state to the second state.

16. The method of claim 15, wherein in the second state, a portion of the target substrate is exposed through the at least one opening and comes into contact with the etching solution.

17. The method of claim 15, wherein in the forming of the pattern on the target substrate,
the rotating structure turns from the second state to a third state in which the rotating blade rotates around a rotating shaft.

18. The method of claim 14, wherein the target substrate is a glass substrate.

19. The method of claim 17, wherein the target substrate comprises a first non-folding region, a second non-folding region spaced apart from the first non-folding region, and a folding region disposed between the first non-folding region and the second non-folding region, and
in the disposing of the target substrate, the at least one opening overlaps the folding region of the target substrate.

20. The method of claim 19, wherein the pattern is formed in the folding region and comprises a groove extending in a direction in which the rotating shaft extends, and
a depth of the groove is less than a thickness of the target substrate.
